(19) United States
(12) Patent Application Publication
(10) Pub. No.: US 2025/0078027 A1
(43) Pub. Date: Mar. 6, 2025

(54) SUPPLY LOCATION SELECTION FOR MULTI-TYPE ORDER FULFILLMENT

(71) Applicant: ORACLE INTERNATIONAL CORPORATION, Redwood Shores, CA (US)

(72) Inventor: Randall B. SMITH, Palo Alto, CA (US)

(21) Appl. No.: 18/240,130

(22) Filed: Aug. 30, 2023

(51) Int. Cl. G06Q 10/0875

(52) U.S. Cl. CPC G06Q 10/0875

(57) ABSTRACT

Systems, methods, and other embodiments associated with selection of supply locations from among multiple candidate locations in order to maximize fulfillment of orders that include multiple item types when there is a shortage of one or more of the item types are described. In one embodiment, a method includes accessing a plurality of orders that include multiple types of items and a plurality of candidate locations for fulfilling the orders. Candidate locations are then selected to fulfill individual orders based on finding the one of the candidate locations that has a lowest value for a flexibility metric. A user interface is generated to display the assignments. In response to a request to finalize the assignments, allocation instructions are generated to allocate the multiple types of items to the orders in accordance with the finalized instructions.

### BACKGROUND

Operations management systems may include software that manages assigning orders for resources to locations that can provide the resources. Where there is a limited supply of the resources, the assignment problem becomes computationally hard. Classic solvers such as Simplex are unable to provide assignment solutions in a sufficiently rapid manner to allow for real-time generation of assignment solutions or real-time exploratory modification of the orders or resource supplies. Parallel processing locally or in the cloud does not solve this speed problem because classic solvers such as Simplex are linear in nature and do not readily parallelize.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a multi-type source assignment system that is associated with supply location selection for maximized fulfillment of orders that include multiple item types when there is a shortage of one or more of the item types across multiple candidate locations.

FIG. 2 illustrates one embodiment of a multi-type source assignment method that is associated with supply location selection for maximized fulfillment of orders that include multiple item types when there is a shortage of one or more of the item types across multiple candidate locations.

FIG. 3 illustrates an example assignment solution of supplies and orders.

FIG. 4 illustrates an example graphical user interface associated with selection of supply locations from among multiple candidate locations in order to maximize fulfillment of orders that include multiple item types when there is a shortage of one or more of the item types.

FIG. 5 illustrates a plot of results of simulation runs of multi-type source assignment techniques using differing location selection criteria.

FIG. 6 illustrates a plot of execution times of simulation runs of multi-type source assignment techniques using differing location selection criteria.

FIG. 7 illustrates an embodiment of a computing system configured with the example systems and/or methods disclosed.

### DETAILED DESCRIPTION

Systems, methods, and other embodiments are described herein that select supply locations from among multiple candidate locations in order to maximize fulfillment of orders that include multiple item types when there is a shortage of one or more of the item types. In one embodiment, a multi-type source assignment system makes assignments between orders for multiple types of item and candidate locations (e.g., warehouses) for fulfilling the orders in real time based on a novel flexibility metric. In one embodiment, the flexibility metric acts to preserve supplies of item types that are scarce. In one embodiment, the multi-type source assignment system chooses a candidate location that is least flexible in terms of the flexibility metric to fill individual orders until no further orders can be filled. This preserves overall flexibility for filling future orders, and causes a maximized amount of orders to be fulfilled when there is insufficient supply to fill all orders. And, basing assignments on the relatively simple (in comparison with the complexity of a classic solver) flexibility metric allows the set of assignments that maximizes the amount of orders fulfilled to be produced in real time.

In one embodiment, the multi-type source assignment technique described herein improves over classic solvers because the multi-type source assignment technique provides a valid assignment solution to a multi-type source-type orders at a pace that is orders of magnitude more rapid than classic solvers. For example, for an order assignment problem of a realistic size, Simplex will take over a day to generate a set of assignments on a benchmark computer system, while the multi-type source assignment technique generates a set of assignments in a few seconds on the same benchmark computer system. In one embodiment, the multi-type source assignment technique described herein improves over classic solvers because the multi-type source assignment technique is interruptable—that is, the multi-type source assignment technique will provide a valid partial set of assignments if stopped early—while classic solvers such as Simplex will not. Both of these improvements enable real-time, exploratory analysis of order-location assignments (for example, in an interactive graphical user interface) where such speed was not previously possible for computers.

In one embodiment, the multi-type source assignment system is presented with orders including multiple types of items and candidate locations for fulfilling those items. The multi-type source assignment system then distributes the orders for fulfillment among the locations so as to cause as many of the orders as possible to be fulfilled. The decisions to assign an order to be fulfilled by one of the locations are based on generating a flexibility metric for the assignment. In one embodiment, the flexibility metric is a measure of how readily a location can fulfill orders for the various types of items. In one embodiment, flexibility metrics for fulfilling the order from each of the candidate locations are compared to find the candidate location that is least flexible for fulfilling orders, as indicated by having a lowest value for the flexibility metric. This least flexible candidate location is chosen to fulfill the order. Assignments of orders to the least flexible candidate locations is iterated over multiple (for example, all) orders to generate a set of assignments for distributing the orders to the multiple locations. The multi-type source assignment system then allocates quantities of the various types of items from the candidate locations to fill the orders in the way specified by the set of assignments.

### Definitions

As used herein, the term “real time” refers to a mode of operation or processing in which events are processed and responded to promptly as they occur, with minimal or negligible delay between an initiating event and a corresponding output or response. The minimal or negligible delay refers to a delay between input and response that is acceptable on a human scale, generally ranging from a few seconds to, at most, a few minutes. As an example of real time operation, in one embodiment, the multi-type source assignment system generates a set of assignments within a few seconds or minutes of a request or other input that initiates a process for generating the assignments. By contrast, as an example of operation that is not in real time, using a classic solver such as Simplex to produce a set of assignments takes many minutes, hours, or even days to complete.

As used herein the term “fulfill” refers to a process of generating a physical shipment of the quantities and types of items described in an order by a time described in the order. Fulfillment may include steps for picking, packing, and shipping the order. Fulfillment may be automated, for example by a warehouse automation system. Note that in one embodiment, in the multi-type source assignment system the orders are to be completely fulfilled, or not at all. An order is completely fulfilled where the quantities of each item type specified by an order are provided totally or entirely, without a shortage of any of the item types specified by the order. The term “fill”, when used herein with respect to an order or demand is synonymous with the term “fulfill”.

It should be understood that no action or function described or claimed herein is performed by the human mind. No action or function described or claimed herein can be practically performed in the human mind. Any interpretation that any action or function described or claimed herein can be performed in the human mind is inconsistent with and contrary to this disclosure.

### —Example Multi-Type Source Assignment System—

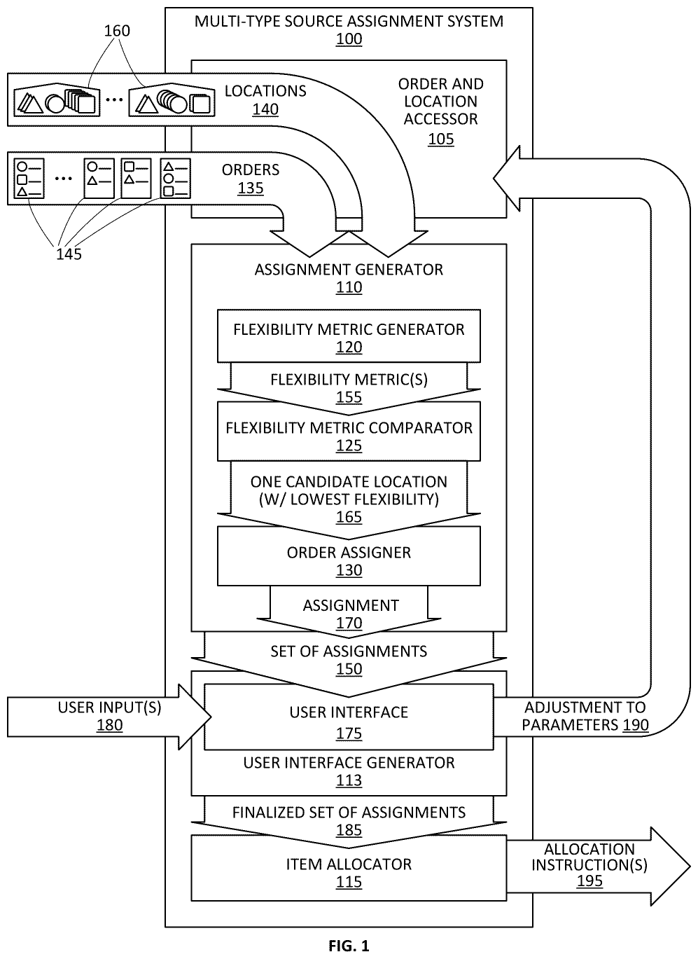

FIG. 1 illustrates one embodiment of a multi-type source assignment system 100 that is associated with supply location selection for maximized fulfillment of orders that include multiple item types when there is a shortage of one or more of the item types across multiple candidate locations. In one embodiment, the multi-type source assignment system is configured to assign supply locations to fulfill the orders with increased speed and reduced consumption of computing resources in an improvement over systems that employ classic solvers such as Simplex to produce assignments between orders and supply locations. Multi-type source assignment system 100 includes components for assigning locations to fulfill individual orders based on a flexibility score that describes how readily the location can fulfill additional orders. In one embodiment, the components of multi-type source assignment system 100 include an order and location accessor 105, an assignment generator 110, a user interface generator 113, and an item allocator 120. In one embodiment, assignment generator 110 further includes a flexibility metric generator 120, a flexibility metric comparator 125, and an order assigner 130.

In one embodiment, order and location accessor 105 is configured to access a plurality of orders 135 and a plurality of candidate locations 140 for fulfilling individual orders 145 in the plurality of orders 135. One or more of the orders 145 include a plurality of item types.

In one embodiment, assignment generator 110 is configured to generate a set of assignments 150 between individual orders 145 in the plurality of orders 135 and candidate locations 140 for fulfilling the individual orders 145. For example, assignment generator 110 is configured to generate one or more assignments between an individual order in the plurality of orders and a candidate location for completely fulfilling the individual order. Assignment generator 110 is configured to select the assignment based on a flexibility metric that describes how readily the candidate location can fulfill orders for the plurality of item types. Assignment generator 110 is configured to generate an assignment for individual orders using flexibility metric generator 120, a flexibility metric comparator 125, and an order assigner 130.

In one embodiment, flexibility metric generator 120 is configured to generate a flexibility metric 155 for each individual candidate location 160. In one embodiment, the flexibility metric 155 quantifies an extent to which the individual candidate location 160 is able to fulfill orders for the plurality of item types. In one embodiment, the flexibility metric 155 indicates an extent to which (or more simply, how readily) the individual candidate location 160 can fulfill orders 135 for the plurality of item types.

In one embodiment, flexibility metric comparator 125, is configured to compare the flexibility metric 155 for each individual candidate location 160 to determine one candidate location 165 that has a lowest value for flexibility metric 155. In one embodiment, order assigner 130 is configured to assign the individual order 145 to be completely fulfilled from the one candidate location 165 that has the lowest flexibility metric. In this way, order assigner 130 is configured to form an assignment 170 between the individual order 145 and the one candidate location 165.

In one embodiment, assignment generator 110 is configured to, in response to generating the assignment 170, update the flexibility metric 155 for the one candidate location 165 to reflect the assignment of a supply from the one candidate location 165 to fulfill the individual order 145. Assignment generator 110 is configured to iterate or repeat the steps of generating the assignment 170 and updating the flexibility metric 155 for each individual order 145 in the plurality of orders 135. In this way, assignment generator 110 is configured to produce a set of assignments 150 between the plurality of orders 135 and the plurality of candidate locations 140.

In one embodiment, user interface generator 113 is configured to generate and update a user interface 175 that is configured to display the set of assignments 150 between the individual orders 145 and candidate locations 140. In one embodiment, user interface 175 is configured to accept a user input 180 that chooses the set of assignments 150 to be a finalized set of assignments 185.

In one embodiment, user interface 175 is configured to accept another user input 180 that makes an adjustment to parameters 190 of one or more of the individual orders 145 or one or more of the individual candidate locations 160. User interface 175 is configured to send the adjustment to parameters 190 to order and location accessor 105. Order and location accessor 105 is configured to apply the adjustment to parameters 190 to the one or more of the individual orders 145 or the one or more of the individual candidate locations 160. In response to the user input 180 that adjusts the parameters, assignment generator 110 is configured to re-generate the set of assignments 150 between the individual orders 145 and the candidate locations 140 based on the adjusted parameters. In one embodiment, the assignment generator 110 is configured to generate or re-generate the set of assignments in real time. The user interface generator 113 is configured to update the user interface 175 to display the re-generated set of assignments 150. In one embodiment, the user interface generator 113 is configured to update the user interface 175 in real time.

In one embodiment, in response to a user input 180 to finalize the set of assignments, item allocator 115 is configured to generate allocation instructions 195 to allocate the plurality of item types from the candidate locations 140 to the individual orders 145 in accordance with the finalized set of assignments 185. More generally, in one embodiment item allocator 115 is configured to allocate the plurality of item types from the candidate locations 140 to the individual orders 145 in accordance with the finalized set of assignments 185.

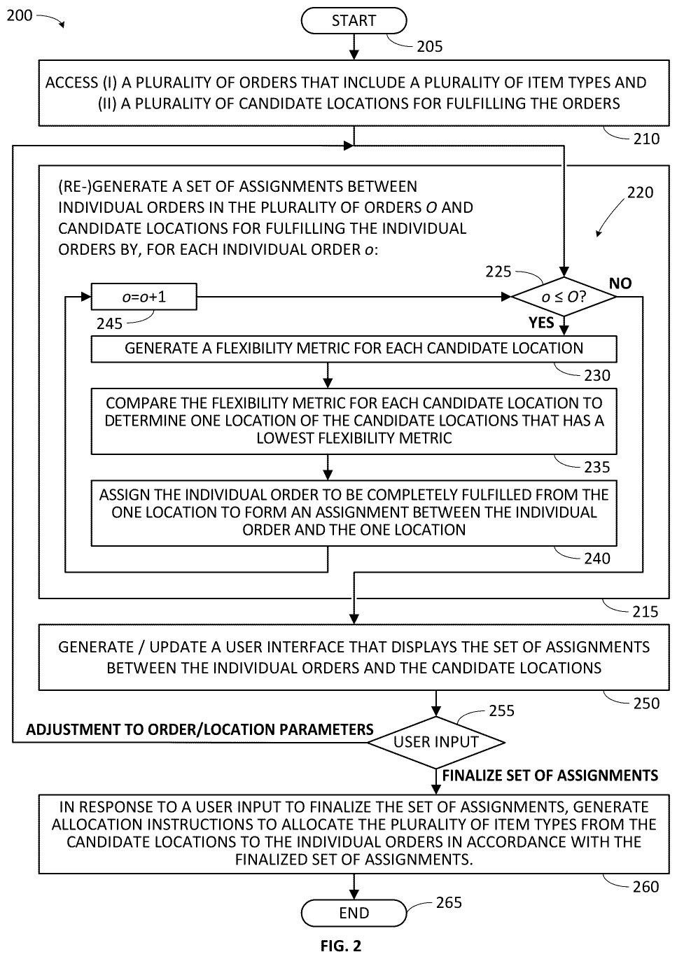

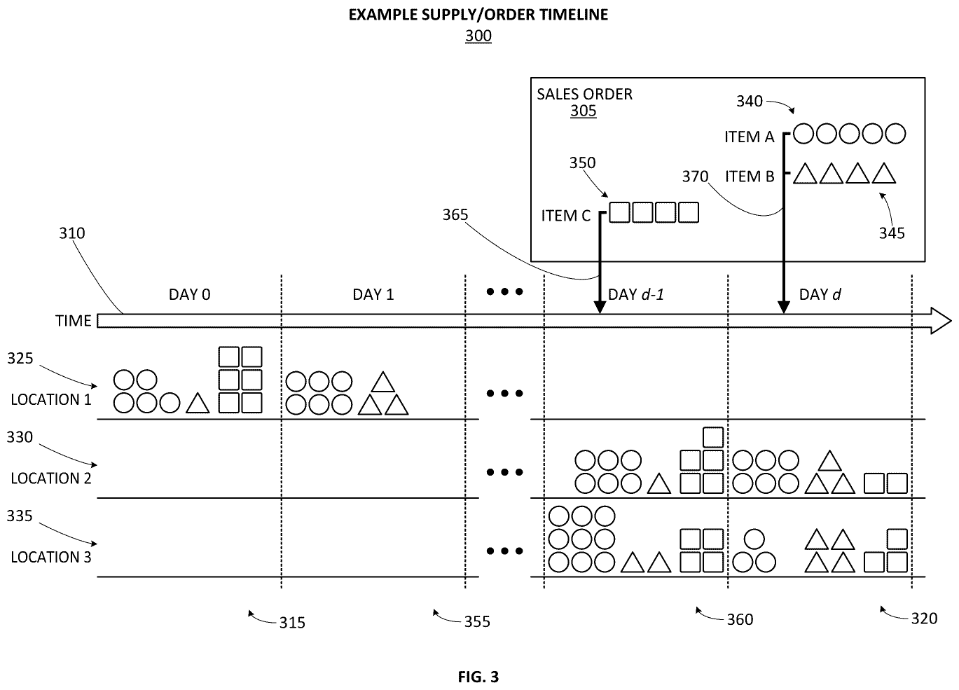

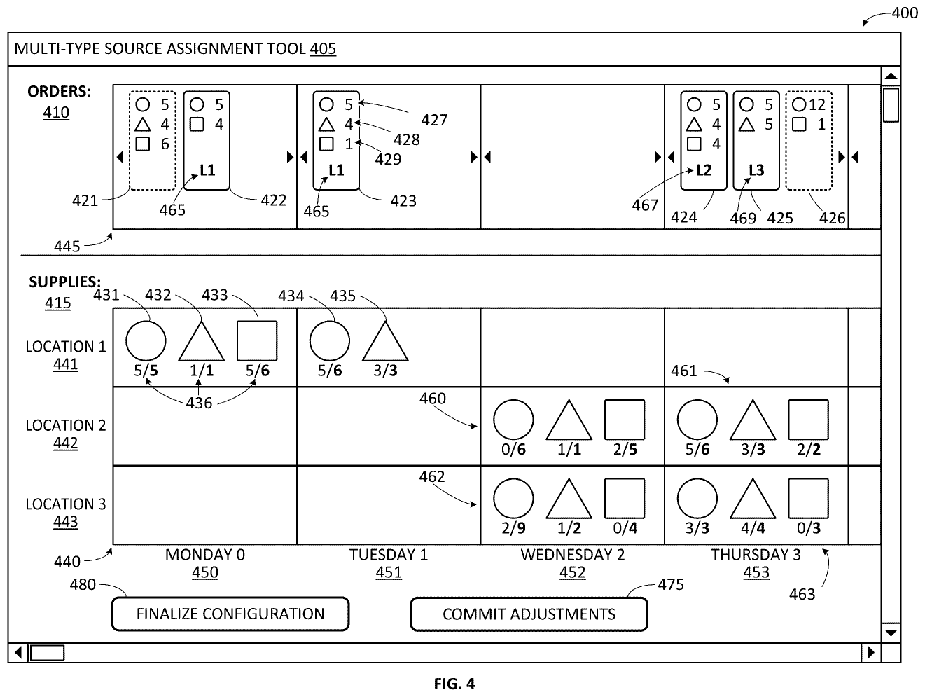

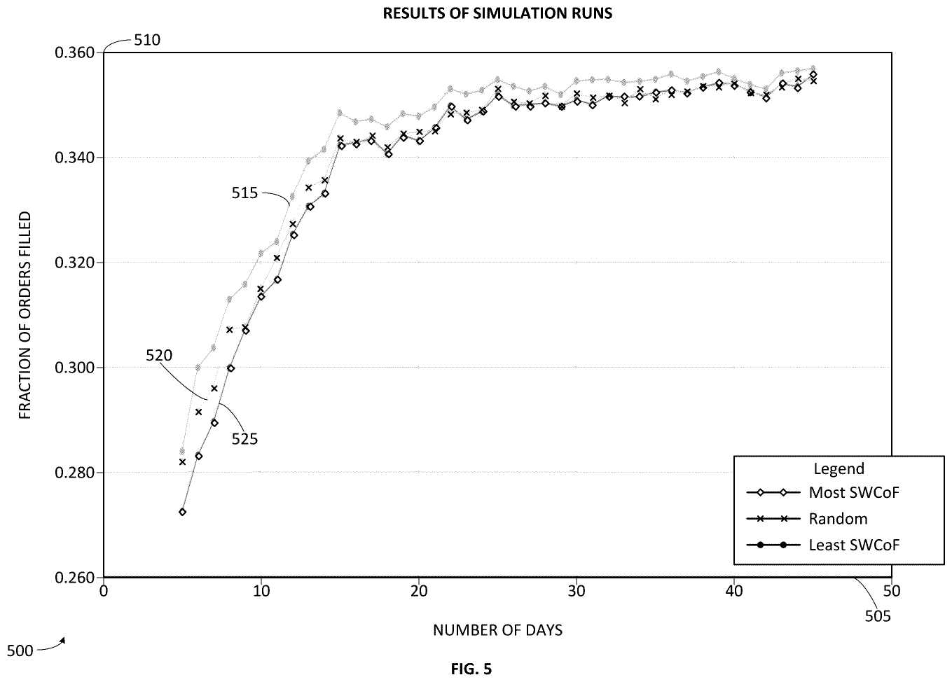

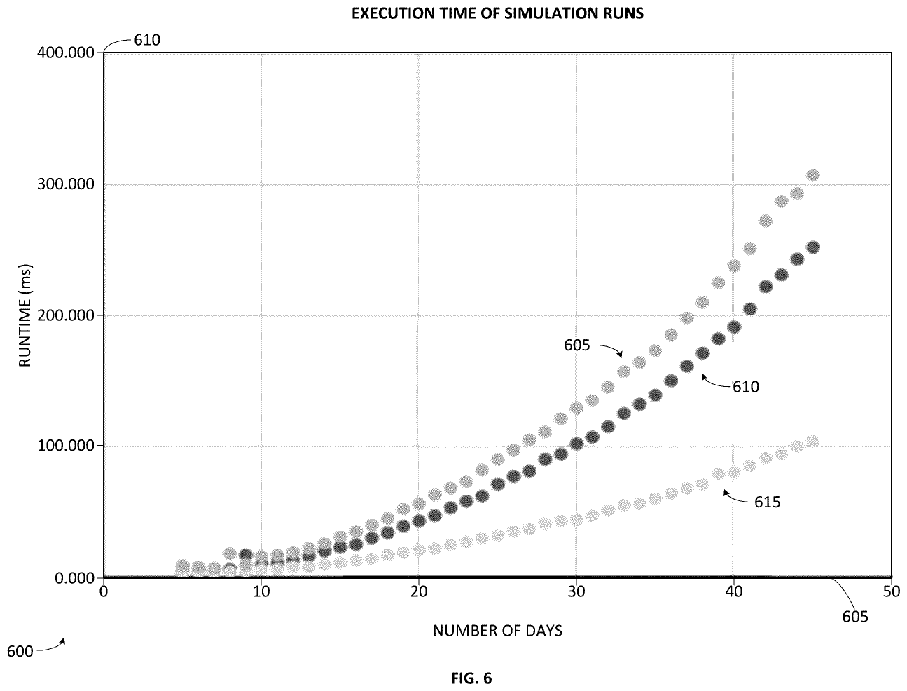

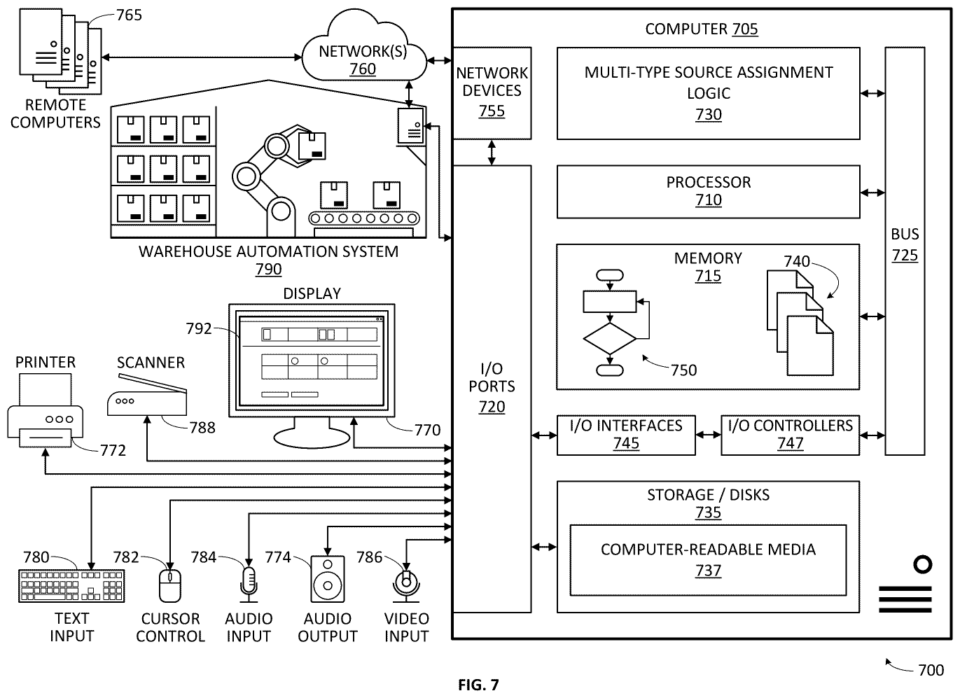

Further details regarding multi-type source assignment system 100 are presented herein. In one embodiment, the operation of multi-type source assignment system 100 will be described with reference to an example multi-type source assignment method 200 shown in and described with reference to FIG. 2. In one embodiment, a multi-type source assignment tool 300 as shown in and described with reference to FIG. 3 makes use of multi-type source assignment system 100 and method 200 to perform interactive, real-time “what-if” explorations of assignment configurations between orders with multiple item types and multiple locations with supplies of the multiple item types. In one embodiment, further details regarding an example multi-type source assignment technique are shown in and described with reference to FIG. 4 Experimental validation of improved accuracy levels of various embodiments of multi-type source assignment system 100 are as shown in and described with reference to FIGS. 5 and 6. Cloud and other computing system embodiments of multi-type source assignment system 100 are shown in and described with reference to FIG. 7.

### —Example Multi-Type Source Assignment System—

FIG. 2 illustrates one embodiment of a multi-type source assignment method 200 that is associated with supply location selection for maximized fulfillment of orders that include multiple item types when there is a shortage of one or more of the item types across multiple candidate locations. At a high level, in one embodiment, multi-type source assignment method 200 operates to choose supply locations (such as warehouses) from which orders that have multiple types of items can be completely satisfied. Multi-type source assignment method 200 assigns the locations to fulfill orders so as to fulfill the most orders in a situation where there is not enough supply of one or more of the types of items to fulfill all orders. Multi-type source assignment method 200 chooses the locations based on a novel flexibility analysis that accounts for scarcity of one or more of the types of items.

In one embodiment, as an overview, multi-type source assignment method 200 retrieves or otherwise accesses unassigned orders and candidate locations for fulfilling the orders. Then, for each order, multi-type source assignment method 200 then selects a location from among the candidates to assign to fulfill the order. Multi-type source assignment method 200 selects the candidate location that has a poorest flexibility score for filling additional orders in view of filling the current order. Once each of the orders is assigned a supply location, multi-type source assignment method 200 displays the current configuration of assignments between orders and locations in a user interface. Note that the speed of generating the assignments based on flexibility analysis allows the user interface to present updated source assignments for multi-type orders in real time, in response to user manipulation of the orders or locations, where such live interactivity was not previously possible for computers. The multi-type source assignment method 200 may accept user inputs to either (i) reconfigure the locations or the orders or (ii) finalize the configuration of assignments. Once the assignments have been placed into a final configuration, the multi-type source assignment method 200 produces allocation instructions to cause the various types of items to be allocated to the orders from the source locations in the way indicated by the finalized configuration.

In one embodiment, multi-type source assignment method 200 initiates at start block 205 in response to a computer system (such as multi-type source assignment system 100) determining that one or more of the following conditions is satisfied: (i) a graphical user interface configured for interactive exploration of location-order assignments has been initialized; (ii) an instruction has been received to fulfill a plurality of orders from a plurality of candidate locations; (iii) an instruction has been received to perform multi-type source assignment method 200 on a plurality of orders and a plurality of candidate locations; (iv) a user or administrator of a importance-based pruning system has initiated multi-type source assignment method 200; (v) it is currently a time at which multi-type source assignment method 200 is scheduled to be run; or (vi) that multi-type source assignment method 200 should commence in response to occurrence of some other condition. In one embodiment, multi-type source assignment method 200 may initiate during an operations management process, for example in response to an indication that a plurality of orders have been captured or entered into an operations management system. Following initiation at start block 205, multi-type source assignment method 200 continues at block 210.

At block 210, multi-type source assignment method 200 accesses (i) a plurality of orders and (ii) a plurality of candidate locations for fulfilling the orders. One or more of the orders includes a plurality of item types. The orders and candidate locations are retrieved or accessed from storage in order to produce assignments that direct the orders to particular locations for fulfillment. In one embodiment, the steps of block 210 may be performed by order and location accessor 105.

The plurality of orders may include one or more orders that include multiple types of items or a plurality of item types. An order may include demands for a diverse range of products or product configurations, referred to herein as “types of items” or “item types”. As a simple example, an order might include a t-shirt, headphones, and shampoo, each of which is discrete item type. Further, items that differ from each other in one or more attributes, such as physical attributes, may also be considered to be discrete item types. As a simple example, t-shirts may differ in attributes of size, color, and cut. Each unique combination of attributes for an item may be considered a separate item type. Thus, for example, a large, green, v-neck t-shirt is one type of item, and a small, red, crew-neck t-shirt is another type of item.

In one embodiment, an order has an identifier that is unique among the orders. In one embodiment, an order includes a date—referred to herein as a “fill-by” date or a “demand date”—that is a due date or other time deadline which the order is to be fulfilled by. And, an order includes one or more demands. A demand is described by a pair of an item type and a demand unit count. The demand unit count may also be referred to as a demand quantity. A demand may also have an identifier that is unique among the demands of the order. The item type may be represented in the demand by an SKU or other identifier that uniquely identifies a particular product. The demand unit count indicates a quantity of the corresponding item type that is to be fulfilled. The demand may also include a fill-by date that is specific to the demand, but generally, the fill-by date for the demand generally corresponds to the fill-by date for the entire sales order.

In one embodiment, an order is represented in a computer system as a data structure for the order, also referred to as an order data structure. The data structure for the order includes an order identifier value, a value for the fill-by date/demand date, and a data structure to represent the one or more demands included in the order. In one embodiment, the data structure for the demands includes a demand identifier value and a series (such as an array or vector) of one or more corresponding pairs of item type and demand unit count/demand quantity to describe the demands. In one embodiment, the order further includes a delivery destination for the order. In one embodiment, the data structure for the demand may also include a flag or tags to indicate supply of the item type that is assigned to fill the demand.

The plurality of candidate locations include various distribution facilities (such as warehouses) that are evaluated as potential sources for fulfilling the orders. The candidate locations may be located at separate geographical or physical locations. The candidate locations may have supply distributions that differ from each other. The candidate locations may have a location identifier that is unique among the locations. In one embodiment, a candidate location holds supplies for one or more of the plurality of item types. A supply is described by an item type, a supply unit count, and an availability date. And, the supply may have a supply identifier that is unique among the supplies. As with the orders above, the item type for a supply may be represented by a SKU or other identifier. The supply unit count indicates a quantity of the corresponding item type that is available for distribution as of the availability date. The availability date is an arrival date or other point in time at which the supply becomes available for distribution, such as when the units of the supply physically enter the inventory of the location.

In one embodiment, a supply location (such as a candidate location that is a candidate for assignment to fulfill an order) is represented in the computer system as a data structure for the location, also referred to as a location data structure. The data structure for the location includes a location identifier, a description of a geographic position of the location, for example with fields for address data and/or GPS or map coordinates. The data structure for the location also includes a data structure to represent the one or more supplies that are made available at the location over time. In one embodiment, the data structure for the supplies includes a series of one or more corresponding triplets of item type, supply unit count (also referred to as supply quantity), and availability date, and which may further include a supply identifier. In one embodiment, the data structure for the supply and for the location may include flags or tags that indicate the orders and demands that are filled by the location or supply. In one embodiment, multiple data structures may be gathered together into a collection or set, and stored together, for instance a collection of the location data structures for the various candidate locations, or for example a collection of the order data structures for the un-assigned orders.

In one embodiment, to access the plurality of orders or the plurality of candidate locations, multi-type source assignment method 200 accepts a user input or other indication of a location in storage or memory of a collection of order data structures or a collection of location data structures, respectively. Then, multi-type source assignment method 200 locates the relevant data structures within a file system or database storage. Once located, the multi-type source assignment method 200 opens the data structure to enable read, write, or modify operations to be applied to the neural network represented by the data structure.

At block 215, multi-type source assignment method 200 generates a set of assignments between individual orders in the plurality of orders and candidate locations for fulfilling the individual orders. In one embodiment, the set of assignments is generated by, for each of the individual orders: (a) generating a flexibility metric for each candidate location; (b) determining one candidate location that has a lowest flexibility metric; and (c) assigning the individual order to be fulfilled by the one candidate location. For example, the generation of the individual assignments is performed in a loop 220 for each order o in the plurality of orders O. Decision block 225 evaluates a base condition for the loop 220, checking to determine whether the current order number o is less than or equal to the number of orders in the plurality of orders. If so, then multi-type assignment method 200 proceeds to block 230 of loop 220. If not, then loop 220 terminates. In one embodiment, the steps of block 215 may be performed by assignment generator 110.

At block 230, multi-type assignment method 200 generates a flexibility metric for each candidate location. The flexibility metric quantifies an extent to which the candidate location is able fulfill orders for the plurality of item types. In other words, the flexibility metric describes how readily the candidate location can fulfill orders for the plurality of item types. In one embodiment, the flexibility metric characterizes the ability to fill orders by determining the temporal average of supply availability for the location, with weighting to account for the overall scarcity or rarity of the various types of items and preference to preserve large supply quantities where possible. The ability of a candidate location to fulfill orders (including further, additional, or subsequent orders that have not already been assigned a supply location) may also be referred to herein as the future utility of the candidate location. Note that the flexibility metrics for the candidate locations are generated anew for each order under consideration. The flexibility metrics for the candidate locations are thus updated in each iteration through loop 220, as the supplies of the various item types are gradually depleted by assignments to fulfill orders.

In one embodiment, the flexibility metric for a candidate location is a value or score produced by the scarcity-weighted center of flexibility (SWCoF) analysis (described in detail elsewhere herein) of a pair of (individual order, candidate location). Additional detail on the flexibility metric is discussed elsewhere herein, for example under the headings “Scarcity-Weighted Center of Flexibility (SWCoF)” and “Example Formula for Scarcity-Weighted Center of Flexibility”. In one embodiment, the steps of block 230 may be performed by flexibility metric generator 120.

At block 235, multi-type source assignment method 200 determines one candidate location that has a lowest flexibility metric. In one embodiment, this determination is made by comparing the flexibility metric for each candidate location to find the one of the candidate locations that is lowest. Or, more generally, the candidate location with a flexibility metric that indicates poorest flexibility of the candidate location is identified. In one embodiment, the multi-type source assignment method 200 identifies the lowest (or poorest) flexibility metric score by iterating through the flexibility scores for the candidate locations and replacing a current lowest flexibility score with any lower flexibility score until the flexibility scores for all candidate locations are considered. The candidate location associated with the current lowest flexibility score at the conclusion of the iteration is the candidate location that has the lowest flexibility metric. In one embodiment, the steps of block 235 may be performed by flexibility metric comparator 125.

At block 240, multi-type source assignment method 200 assigns the individual order to be completely fulfilled from the one candidate location that has the lowest flexibility metric. This serves to form an assignment between the individual order and the one candidate location. In one embodiment, the assignment is inserted into the set of assignments that is being generated by loop 220. In one embodiment, the set of assignments is a data structure. For example, the set of assignments may be an array or vector of pairs of identifiers for orders and identifiers for the locations that are assigned to fill the orders. In one embodiment, the set of assignments may further include other information corresponding to the assignment pairs, for example, identifiers for one or more specific supplies at the assigned location that are allocated to fill the orders, along with quantities allocated from the specific supply to fulfill a particular demand in the order. In one embodiment, the steps of block 240 may be performed by order assigner 130.

In this way, multi-type source assignment method 200 generates an assignment between an individual order in the plurality of orders and a candidate location for completely fulfilling the individual order. The assignment is selected based on a flexibility metric that describes how readily the candidate location can fulfill orders for the plurality of item types. Then, in response to generating the assignment, multi-type source assignment method 200 updates the flexibility metric for the candidate location to reflect the assignment of a supply from the candidate location to fulfill the individual order. The steps of generating the assignment and updating the flexibility metric are iterated for each individual order in the plurality of orders to produce a set of assignments between the plurality of orders and the plurality of candidate locations. At block 245, multi-type source assignment method 200 increments the current individual order under consideration. The loop 220 then returns to decision block 225 and proceeds to determine an assignment for the next individual order.

At the conclusion of loop 220, multi-type source assignment method 200 has attempted to assign a supply location to fulfill each individual order. Where one or more of these attempts is successful, a set of assignments between candidate locations and individual orders has been generated.

At block 250, multi-type source assignment method 200 generates (or updates) a user interface (such as user interface 175) that displays the set of assignments between the individual orders and the candidate locations. In one embodiment, the multi-type source assignment method 200 fetches or otherwise accesses (i) the individual orders and their attributes (e.g., order ID, demand date, demand item types, and demand quantities); the supply locations and their attributes (e.g., location ID, supply IDs, supply item types, supply item quantities, and supply availability dates); and the set of assignments from storage. Then, multi-type source assignment method 200 generates visual components and information to represent the supply locations, orders, one or more of their respective attributes (such as item quantities, item types, and demand or availability date) and the assignments between them. Multi-type source assignment method 200 updates a display to show the visual components and information arranged on a display in the form of the user interface.

This process may be repeated dynamically in response to interactive updates to the set of assignments. For example, the multi-type source assignment method 200 may present an initial set of assignments between individual orders in a plurality of orders and candidate locations for fulfilling the individual orders in the user interface. One or more of the orders include a plurality of item types. The initial set of assignments is generated without user-input adjustments to the parameters of the orders and candidate locations.

Then, at block 255, the multi-type source assignment method 200 accepts a first user input. The first user input adjusts (i) one or more of the individual orders or (ii) one or more of the candidate locations (or the supplies therein). Thus, at block 255, multi-type source assignment method 200 determines whether the input is an adjustment to parameters of an order, supply, or location, or whether the input is an instruction to finalize the set of assignments.

In one embodiment, where the user input is an adjustment, the multi-type source assignment method returns to block 215 to re-generate the set of assignments based on the adjustment. In response to the first user input, the multi-type source assignment method 200 re-generates the set of assignments between the individual orders and the candidate locations, as adjusted, in real-time. The set of assignments is re-generated by, for each of the individual orders: (a) generating a flexibility metric for each candidate location; and selecting one location of the candidate locations that has a lowest value for the flexibility metric to fulfill the individual order to assign the individual order to the one location in the re-generated set of assignments. As discussed above, the flexibility metric indicates an extent to which the candidate location can fulfill further orders for the plurality of item types. Multi-type source assignment method 200 then completes the re-generation by automatically updating the user interface to display the re-generated set of assignments.

In one embodiment, the set of assignments may be presented in a user interface that is configured to accept a user input to finalize the set of assignments. In one embodiment, where the user input is an adjustment, the multi-type source assignment method 200 proceeds to block 260 to finalize the set of assignments. Finalizing the set of assignments accepts a current configuration of the set of assignments. Finalizing the set of assignments may trigger or initiate a further action. For example, finalizing the set of assignments may initiate the generation of allocation instructions on how to fulfill the orders according to the finalized set of assignments. Or, for example, finalizing the set of assignments may initiate autonomous or automated fulfillment of the orders by warehouse automation systems. Additional detail on the user interface is described elsewhere herein, for example with reference to FIG. 4. In one embodiment, the steps of block 250 may be performed by user interface generator 113.

At block 260, in response to a user input to finalize the set of assignments, multi-type source assignment method 200 generates allocation instructions to allocate the plurality of item types from the candidate locations to the individual orders in accordance with the finalized set of assignments. In one embodiment, where the set of assignments is re-generated one or more times prior to finalizing the set of assignments, multi-type source assignment method 200 generates and transmits allocation instructions to allocate the plurality of item types from the candidate locations to the individual orders in accordance with the re-generated set of assignments. In one embodiment, multi-type source assignment method 200 generates allocation instructions to include instructions that are specific to the individual candidate locations. The instructions for the candidate locations list which orders that the candidate location is to fill, and the specific supplies (by supply ID and/or supply item type and availability date) that are assigned to fill the orders.

Multi-type source assignment method 200 may generate the allocation instructions by composing a computer-readable electronic message. Multi-type source assignment method 200 may then transmit the electronic message bearing the allocation instructions to a computer system (such as a warehouse automation system) associated with the candidate location. In one embodiment, multi-type source assignment method 200 accesses a template for composing the electronic message, inserts the finalized set of assignments or a portion thereof that is specific to one or more of the supply locations, and transmits the message.

In one embodiment, the electronic message is configured to be transmitted over a network, such as a wired network, a cellular telephone network, wi-fi network, or other communications infrastructure. The electronic message may be composed and then transmitted for subsequent presentation on a display or other action. In one embodiment, the electronic message may be presented in a user interface such as a graphical user interface (GUI) by extracting the content of the electronic message by a REST API that has received the electronic alert. The electronic message may be configured to be read by a computing device. The electronic message may be configured as a request (such as a REST or SOAP request) used to trigger initiation of an automated function. For example, the electronic message may be used to trigger a warehouse automation system to initiate automated fulfillment of orders in accordance with the allocation instructions. At the conclusion of block 260, multi-type source assignment method 200 proceeds to end block 265, where multi-type source assignment method 200 terminates.

At the completion of multi-type source assignment method 200, an interactive interface has been presented that allows on-the-fly, real time adjustment to assignment configurations for individual orders for multiple item types and supply locations for fulfilling the individual orders. The user interface may be used to interactively explore alternative configurations of assignments until the user is satisfied with a configuration. The user interface may then be used to finalize or accept the final configuration, and initiate fulfillment of the orders. The flexibility metric described herein provides a speed improvement over classic solvers that allows source assignment for orders with multiple item types to be performed interactively in real time, where such interactivity was not previously possible to computers.

### —Further Embodiments of Multi-Type Source Assignment Method—

In one embodiment, the flexibility metric accounts for scarcity of a resource in the distribution of supplies for a given location. Thus, in one embodiment, generating the flexibility metric for a candidate location (as discussed at block 230 above) further includes determining scarcity of supply for one or more of the plurality of item types. The flexibility metric is based at least in part on the scarcity of supply. For example, the multi-type source assignment system may generate the flexibility metric for the candidate location based at least in part on a scarcity of supply for one or more of the plurality of item types.

Also, in one embodiment, the multi-type source assignment system generates the flexibility metric for the candidate location based at least in part on quantities and availability dates for supplies of each item type in the candidate location. In one embodiment, generating the flexibility metric for a candidate location (as discussed at block 230 above) includes further steps to generate the flexibility metric. Scarcity of supply is determined for each item type of the plurality of item types. Daily supplies of each item type that are in inventory in the candidate location are determined. Total supplies of each item type that are available over multiple days in the candidate location are also determined. A number of demands are determined for each item type in the individual order. And, a day that the demands occurs is determined for each item type. The flexibility metric for a candidate location is then generated based on the scarcity of supply, the daily supplies, the total supplies, the number of demands, and the day that the demand occurs for each item type. Additional detail on the generation of the flexibility metric is discussed elsewhere herein, for example under the heading “Example Formula for Scarcity-Weighted Center of Flexibility”.

In another embodiment, scarcity of supply is determined for each individual item type of the plurality of item types. A center of flexibility is determined in order to provide the plurality of item types that are available in the candidate location over increments of time (such as a day or an hour) that precede an increment of time on which the individual order is to be fulfilled. And, the flexibility metric for the candidate location is determined at least in part by weighting the contribution of the individual item type to the center of flexibility by the respective scarcity of supply for the individual item type.

In one embodiment, the multi-type source assignment system determines a total amount of supply that is available in the candidate location (for example as discussed below with reference to FIG. 3). The flexibility metric is based at least in part on the total amount of supply.

In one embodiment, locations that are deemed unsuitable for filling orders based on failing to satisfy a geographic condition may be removed from the candidate locations (for example as described below under the heading “Filtering the Set of Candidate Locations”). For example, prior to generating a flexibility metric for each candidate location at block 230, the multi-type source assignment method further includes filtering out one or more candidate locations from the plurality of candidate locations based on a geographic proximity of the candidate location to a delivery destination of the individual order.

In one embodiment, where one or more types of items are perishable or otherwise have a shelf life, locations where the amount of time between the fill-by date of an order and the availability date of a supply may be removed from the candidate locations (for example as described below under the heading “Filtering the Set of Candidate Locations”). For example, prior to generating a flexibility metric for each candidate location at block 230, the multi-type source assignment method further includes filtering out one or more candidate locations from the plurality of candidate locations based on a shelf-life of one or more items types in the individual order.

Thus, in one embodiment, prior to generating the assignment, multi-type source assignment system filters out one or more candidate locations from the plurality of candidate locations based on (i) a geographic proximity of the candidate location to a delivery destination of the order or (ii) a shelf-life of one or more items types in the order. In one embodiment, the filtering is performed prior to generating and presenting an initial set of assignments in the graphical user interface.

In one embodiment, the multi-type source assignment system accepts adjustment of the set of supply-to-order assignments through a user interface, and the supply-to-order assignments are re-generated in real time in accordance with the adjustment to provide an interactive response to the adjustment in the user interface. For example, a user input is accepted that adjusts parameters of one or more of the individual orders or one or more of the candidate locations. In one embodiment, a second user input is accepted through the user interface. The user interface that displays the set of assignments between individual orders and candidate locations is updated in real time in response to the user input. Or, in one embodiment, a second user input adjusts parameters of one or more of the individual orders or one or more of the candidate locations. In response to the user input, the set of assignments between the individual orders and the candidate locations is regenerated in real time based on the adjusted parameters. And, the user interface is updated in real time to display the re-generated set of assignments. Additional detail on real-time update in response to user adjustment is provided elsewhere herein, for example under the heading “Example Graphical User Interface”.

In one embodiment, multi-type source assignment system is implemented using a variety of special-purpose data structures. In one embodiment, the individual orders are represented by order data structures that include a demand date for fulfillment of the order, and one or more demand quantities for one or more of the plurality of item types. The candidate locations are represented by location data structures that include a geographic position for the candidate location and one or more supplies for one or more of the plurality of item types. And, the supplies are represented by supply data structures that include one or more supply quantities for one or more of the plurality of item types and one or more availability dates at which the supply becomes available or otherwise obtainable at the candidate location for fulfilling orders.

In one embodiment, the multi-type source assignment system generates allocation instructions that can be used to cause one or more automated warehouses to fill the orders. In one embodiment, generating the allocation instructions (as described at block 260) further comprises generating an allocation instruction for a particular candidate location that includes a subset of the orders that are assigned to the particular candidate location for fulfillment.

In one embodiment, the instructions further cause the warehouse automation system to generate the control instructions for the warehouse automation system from the allocation instructions. In one embodiment, the instructions further cause the multi-type source assignment system to generate the control instructions for the warehouse automation system from the allocation instructions. In either case, the control instructions are configured to cause the warehouse automation system to automatically fulfill one or more of the individual orders from an assigned location that is assigned to the one or more of the individual orders in the re-generated set of assignments.

Then, the multi-type source assignment system takes further steps to automatically fill the orders. The allocation instruction is transmitted to a warehouse automation system that is configured to fulfill orders from the particular candidate location. In one embodiment, in response to receiving the allocation instruction, the allocation instruction is parsed to generate control instructions for fulfilling the subset of the orders. The control instructions are then executed by the warehouse automation system to automatically fulfill the subset of the orders. The control instructions are configured to direct the operation of various automated equipment for picking, packing, and/or shipping of assigned orders that is included in the automated warehouse system. In one embodiment, allocating the plurality of item types from the candidate locations to the individual orders in accordance with the set of assignments (as discussed in block 260) further causes the computer system to control automated warehouse equipment of one or more of the candidate locations to automatically fulfill the orders according to the set of assignments.

For example, the instructions cause the automated equipment of the warehouse automation system to: (i) automatically locate within an automated warehouse the supplies of the particular item types in an order that is assigned; (ii) physically manipulate or maneuver the ordered quantities of each type of item in the order from the supply location to a packing location to automatically pick the order; (iii) physically manipulate or maneuver the ordered quantities into a package such as a box, bag, or envelope; (iv) generate a shipping label from destination information included in the order and apply the label to the package; and (v) physically maneuver the package into a location for subsequent shipping. In one embodiment the package may be loaded onto an automated delivery vehicle such as an autonomous delivery robot, self-driving delivery vehicle, or drone that is programmed to proceed to the destination specified by the order, and the autonomous delivery vehicle commanded to proceed to the destination.

In one embodiment, multi-type source assignment method 200 may be stored as computer-executable instructions stored on one or more non-transitory computer-readable media. When the instructions are executed by a computer system, the instructions cause the computer-system to execute steps of multi-type source assignment method 200. In one embodiment, the computer system may include one or more of: a processor; a memory operably connected to the processor; a display device configured with a user interface to show an interactive set of assignments; and the non-transitory computer readable media accessible by the processor. In one embodiment, the computer system further includes a warehouse automation system configured to fulfill orders for the plurality of item types from one or more of the candidate locations.

In one embodiment, the warehouse automation system is configured to fulfill orders for the plurality of item types from one or more of the candidate locations. In response to the allocation instructions, the warehouse automation system generates control instructions for fulfilling one or more of the individual orders by the warehouse automation system from an assigned location that is assigned to the individual order in the re-generated set of assignments. And, the warehouse automation system executes the control instructions to automatically fulfill the one or more of the individual orders from the assigned location.

### Discussion and Additional Embodiments

Computer systems for operations management may be used by entities that have product supply at multiple locations (e.g.: warehouses) that is restocked at various times. Computerized selection of which location to use to fulfill a given sales order faces computational challenges when the there is insufficient supply to fill all orders. The computational challenges are compounded when the entity has multiple types of products or items in the supply, and takes orders that may include one or more of the multiple item types.

In short, automated supply-to-order assignment is computationally difficult for the case in which an order includes demands for multiple item types, all of which are to be filled from a single one of many possible supply locations (warehouses) of supplies that become available in a time-dependent manner. The problem is combinatorically complex, involving hundreds or thousands of objects. The problem is amenable to integer programming optimization techniques, but even on much simpler problems, the classic solvers such as Simplex and other integer programming methods are far too slow. For example, Simplex takes hours or even days to arrive at a result for a real-world scale task of assigning supplies with time-dependent availability from one of several locations to fulfill orders for multiple item types. Other classic solvers based on integer linear programming, dynamic programming, branch-and-bound techniques, and metaheuristic algorithms (such as genetic algorithms or simulated annealing) are similarly slow.

In one embodiment, the multi-type source assignment techniques provided herein enable a computer to provide an interactive experience in which a user can investigate “what if” scenarios and see the results in real time. In such interactive investigation, the computer accepts user inputs that adjust parameters of the supply-to-order assignments, re-generates the assignments based on the adjusted parameters, and presents the results in a user interface, thereby allowing the user to see how the change affects the assignments. Consequently, the assignment process should take a few seconds or less in order to be used for interactive operation. The slow results of the compute-intensive solver algorithms render them entirely unsuitable for interactive generation (or re-generation) of supply-to-order assignments. But, the multi-type source assignment techniques shown and described herein improve the speed of (or re-generation) of supply-to-order assignments to a few seconds or less. This is fast enough to allow for interactive use. The improvements in speed are realized using equivalent (or the same) hardware configurations for benchmarking. Thus, the multi-type source assignment techniques described herein provide a good solution while providing an interactive experience.

In general, there can be multiple item types within an order. If supply is plentiful, the task of selecting which supply to ship to which order may be a fairly simple one, in that there are many equivalent ways to map supply to order, all ways filling all orders. But, at times supply is limited for some or all items. In such cases, an automated supply-to-order assignment algorithm must select which orders to fill, and which orders to neglect in order to optimize an objective function. In one embodiment, the multi-type source assignment system makes selections from among candidate supply locations based on an objective function of filling as many orders as possible. This objective may be referred to as the “fill rate objective”. Note, in one embodiment, order fulfillment is “all or nothing”. That is, the when assigning supply to fulfill orders, orders are either completely filled or left unfilled, and orders are not partially filled.

In one embodiment, the multi-type source assignment system is subject to one or more of a variety of constraints. The multi-type source assignment techniques described herein are addressing a setting in which each order has a particular “fill-by” date, and each supply location has supply arriving at various dates as well. Hence, time has a substantial influence on the supply-to-order assignments. Supply can only be used to fill orders with fill-by dates that occur after the supply becomes available at the location. In one embodiment, as a further constraint, all the requested item types in an order are to be shipped from a single supply location.

### —Filtering the Set of Candidate Locations—

In one embodiment, the multi-type source assignment techniques described herein are agnostic to (or independent of) the effects of geographic situation (physical position of the supply location) of the supply locations. Any location that can fill an order is considered equally suitable for fulfilling the order. There is no accounting for various shipping costs. Where the geographic position of the supply locations is to be considered, the candidate locations may be filtered to remove locations that do not satisfy the geographic conditions (such as shipping cost, national borders, proximity to delivery destination etc.) prior to generating the assignments.

In one embodiment, to filter out locations that are unsuitable due to geographic conditions, a pre-set threshold for a geographic condition is retrieved from storage, the values of the geographic condition applicable to each of the candidate locations are determined and evaluated against the threshold. Where the threshold is satisfied by the value of the geographic condition that is applicable to the candidate location, the candidate location will be passed through the filter and retained in the plurality of candidate locations. And, where the threshold is not satisfied by the value of the geographic condition that is applicable to the candidate location, the candidate location will be filtered out and removed from the plurality of candidate locations. In one embodiment, this removal is a temporary removal from consideration when generating the flexibility metrics for filling a given individual order, and the removal is rescinded following generation of the flexibility metrics for filling the individual order. After filtering, the remaining candidate locations will be a set of equally suitable locations in view of the geographic considerations.

For example, multi-type source assignment system may access a pre-set threshold for geographic proximity between candidate location and delivery destination of an individual order under consideration. Then, multi-type source assignment system determines the geographic proximity of each of the candidate locations to the delivery destination of the individual order. Multi-type source assignment system evaluates the geographic proximities of the candidate locations against the threshold to determine whether or not the candidate locations exceed a maximum geographic distance from the delivery destination. If so, the candidate locations are removed from consideration for filling the individual order associated with the delivery destination.

In one embodiment, the multi-type source assignment techniques described herein are agnostic to (or independent of) perishability of supply. In other words, there is no “aging out” of product. An item of supply on day 0 is considered suitable for filling a demand on day 100. This approach is legitimate for supplies of concrete blocks, but is questionable at best for avocados. Where perishability or aging of a product is a consideration, the candidate locations may be filtered to remove locations that have supply that is too early in time to be used to fill the orders.

In one embodiment, the multi-type source assignment system filters out locations for which a perishable supply would exceed its shelf life before the fill-by date of the individual order. The fill-by date of the order, the availability dates of the perishable supplies at the locations, and the shelf life of the perishable supplies are accessed. Where the time between the fill-by date and an availability date of the perishable supplies at a location exceeds the shelf life, the location is filtered out of the candidate locations. After this “shelf-life” filtering, the remaining candidate locations will be a set of equally suitable locations for supplying orders for the perishable product. As with the geographic filtering above, the removal of the location due to shelf-life filtering is temporary, and the location is returned to the candidate locations before consideration of the subsequent order.

Note that these filtering operations add very little processing time to the multi-type source assignment methods, and may therefore be used in the real-time interactive operations of the multi-type source assignment system.

### —Scarcity-Weighted Center of Flexibility (SWCoF)—

In one embodiment, regardless of how the set of candidate locations is formed, the multi-type source assignment techniques described herein selects from among the candidate locations to obtain a high fill rate. In one embodiment, the multi-type source assignment techniques described herein selects a supply location with which to fill a given order under the constraints described above, while maximizing the overall fill rate objective. In one embodiment, the multi-type source assignment techniques described herein employ a particular criterion, referred to herein as “Scarcity-Weighted Center of Flexibility” (SWCoF) or “flexibility metric”. For a given order, the SWCOF will determine a location from a group of candidate locations based on the goal of leaving the remaining overall supply distribution most flexibility in filling the remaining orders. In one embodiment, the SWCoF (flexibility metric) is a numerical value that characterizes how well a distribution of remaining supply at a location can deal with filling future orders. In other words, the value of the flexibility metric quantifies an extent to which the current order and additional orders for the plurality of item types can be fulfilled from the distribution of supplies in a location that have not already been allocated.

In one embodiment of a multi-type source assignment method, for a given order O, the SWCoF (flexibility metric) is calculated for each candidate location, and then the location with the least value for SWCoF is selected and assigned to fill the given order O. This numerical value for SWCoF of a location changes throughout the assignment process because supply at the location gets “used up” as the supply at the location gets assigned to fulfill orders.

Note that, in one embodiment, the selecting locations based on the SWCoF as described herein is entirely independent of the method used to select the sequence (or order) in which orders are considered for possible assignment. In one embodiment, the orders may be considered for assignment by the multi-type source assignment system in a sorted sequence, such as by ascending size of order. Or, in one embodiment, the orders may be considered for assignment by the multi-type source assignment system in an arbitrary or random sequence, for example in a sequence in which the orders are stored in a file or database. In short, location selection and the sequence by which the multi-type source assignment system addresses the orders one after the next are independent of each other.

This differs from an approach used to optimize fill rate where all items are of a single type. In the case of a single item type, the approach to optimize fill rate begins the overall assignment by sorting the orders with the easiest to fill orders at the front of the list. In the case of a single item type, an order is equivalent to a demand, and the easiest to fill demand is the one with the smallest unit count. It is proven that, in the case of a single item type, sorting demands by smallest unit count first gives an optimal fill rate result. But in the case (addressed by the present disclosure) in which an order contains multiple demands, the ascending unit-count sort may not (and is unlikely to) produce an optimal fill rate result.

FIG. 3 illustrates an example assignment solution 300 of supplies and orders. A single sales order 305 is represented above a directional timeline 310 that represents the passage of time from an initial day 0 315 onward to a future day d 320. Supply locations (e.g., warehouses), including location 1 325, location 2 330, and location 3 335, are represented in rows below the timeline 310. In actual application there can be hundreds (or more) of orders and dozens (or more) of locations, although this varies based on the entity implementing the multi-type source assignment system.

In one embodiment, each order (such as sales order 305) represents a collection of demands. And, each demand may be represented by an item type such as a SKU (stock keeping unit) with a corresponding unit count and a fill-by date. Sales order 305 includes a first demand 340 for five units of item A (represented by circles), a second demand 345 for four units of item B (represented by triangles), and a third demand 350 for four units of item C (represented by squares). Sales order 305 has a shared fill-by date on or after day d 320 for the demands 340, 345, and 350.

In one embodiment, each location represents a collection of supplies of multiple types of items as they become available over the course of the timeline 310. And, each supply may be represented by an item type such as a SKU with a corresponding unit count and an availability date that indicates when the supply becomes available at the location for fulfilling orders. Location 1 325 has supplies of five units of item A, one unit of item B, and six units of item C becoming available on day 0 315 and also has supplies of six units of item A and three units of item B becoming available on day 1 355. Location 2 330 has supplies of six units of item A, one unit of item B, and five units of item C becoming available on day d−1 360 and also has supplies of six units of item A, three units of item B, and two units of item C becoming available on day d 320. Location 3 335 has supplies of nine units of item A, two units of item B, and four units of item C becoming available on day d−1 360 and also has supplies of three units of item A, four units of item B, and three units of item C becoming available on day d 320.

In the illustrated assignment solution 300, there is sufficient supply in each of the locations 325, 330, 335 to fill the sales order 305. However, location 1 325 has its supply ready to go—that is, available for distribution—on day 0 315 and day 1 355. Location 1 325 is capable of filling orders with fill-by dates occurring on or after day 0 315, while location 2 330 and location 3 335 are capable only of filling orders with fill-by dates occurring on or after day d−1 360. Because the supplies of location 2 330 and location 3 335 do not become available (for example, by being produced at or delivered to the location) until day d−1 360 or day d 320, they cannot be used to fill demands due in the past, with fill-by dates prior to day d−1 360 or day d 320. Thus location 1 325 is in a position to fill more orders than location 2 330 and location 3 335. Consequently, the distribution of supply across the timeline 310 discourages use of location 1 325 to fill sales order 305 when compared with location 2 330 and location 3 335. Using location 1 is to be avoided so as to save the earlier supply on day 0 315 and day 1 355, as the earlier supply is more capable of future utility.

To enable the multi-type source assignment system to automatically determine which supply location to draw from, in one embodiment the system evaluates several factors. In one embodiment, a first factor is an average time at which items become available in the distribution of supply for a given supply location, a metric otherwise referred to herein as a “center of flexibility.” In one embodiment, the multi-type source assignment system measures the distribution of supply over the timeline 310 for the location by calculating a center of flexibility for the given location. In one embodiment, the center of flexibility for a location is a point in time (along timeline 310) that the supply in the location is centered around. For example, the center of flexibility represents a mean availability date of the individual supply units in the location. The center of flexibility is thus a temporal average or mean for the availability of supplies at a location. The center of flexibility is an indication of how far ahead in time the bulk of the utility is for the supplies of the location. (The “utility” of a supply or location refers to the ability to fill orders from the location). The center of flexibility is roughly analogous to a “center of mass” for availability of the supplies. Because there are multiple demands in an order, each with its own item type, in one embodiment the multi-type source assignment system calculates the center of flexibility for each demand and combines them (for example as discussed below with reference to EQs. 1 and 2 below). But to combine the centers of flexibility for each demand by simply summing or averaging across demands does not account for item “scarcity,” a concept discussed immediately below.

In one embodiment, item scarcity is also a factor evaluated by the multi-type source assignment system. Examining FIG. 3, it can be observed that filling the triangular item demand—second demand 345 for four units of item B, represented by triangles—was a close call. There is barely enough supply of item B in each location to fulfill second demand 345. In contrast the circular item demand—first demand 340 for five units of item A, represented by circles—were more easily filled. For item A (circles), supply is relatively plentiful. Intuitively, the assignment process would be expected to proceed more easily when it comes to filling demands for item A (circles) than filling demands for item B (triangles). Consequently, the multi-type source assignment system will weigh the item type contribution by some notion of scarcity. The measure of scarcity for a type of item that is employed herein is defined by the following ratio: the total number of units of that type among all unfilled demands divided by the total available supply of that type among all locations. Other metrics for scarcity of a type of item may also be used, such as relative abundance of the type with respect to one or more other types, or frequency distribution of the availability of the type over time. In one embodiment, weights for item scarcity is applied to the center of flexibility (for example using the term S (T) as discussed below with reference to EQs. 1 and 2 below).

In one embodiment, a third factor evaluated by the multi-type source assignment system is the total available supply in a location. In other words, the multi-type source assignment system considers the size of the supply—that is, total of the unit counts for the various types of units—at each location. The multi-type source assignment system compares the total quantity across item types for each location, and chooses to fill from location with the least total supply. For example, in FIG. 3, the total supply of item A (circles) and item B (triangles) is larger in location 3 335 than in location 2 330, while the total supply of item C (squares) is of equal quantity in location 2 330 and location 3 335. The multi-type source assignment system therefore chooses to fill the order 305 from the location with a smaller overall quantity of units of supply: location 2 330. This leaves location 3 335 capable of filling demands of a size greater than what remains in location 2 330. And, choosing to fill from location 2 330 leaves location 3 335 capable of filling demands of a size greater than what location 2 330 would be able to fill if order 305 were filled from location 3 335. In short, the multi-type source assignment system operates to preserve larger supplies when there are alternative, smaller supplies that can be used to fill an order. This provides the multi-type source assignment system with an improved fill rate for larger orders, where the supplies might otherwise become too small to fill larger orders. In one embodiment, the total available supplies for each of the locations is a term included in the scarcity-weighted center of flexibility (for example, N_{L}(L) as discussed below with reference to EQs. 1 and 2 below).

As mentioned above, an individual demand in an order may include a fill by date or due date. Arrow 365 indicates a fill by date of Day d−1 360 for demand 350 by pointing to Day d−1 360 along timeline 310. Similarly, arrow 370 indicates that both demand 340 and demand 345 share a fill by date of Day d 320. In one embodiment, even though the two fill dates for demand 340 and demand 345 happen to be the same, the fill dates are two independent values held inside the respective demand data structures for demand 340 and demand 345.

### —Example Formula for Scarcity-Weighted Center of Flexibility—

Consider an order O with several candidate locations at a moment when a multi-type source assignment is considering whether to use location L to fill the demands of order O. In one embodiment, when generating the scarcity-weighted center of flexibility (SWCoF) flexibility metric, the multi-type source assignment system may perform a calculation of the SWCoF after tentatively allowing L to fill the demands of order O. This may be referred to as the “post-assignment” method. Extensive simulated tests have shown no statistically significant benefit to the post-assignment approach. But, the post-assignment method can be significantly slowed because a tentative assignment is performed for each location check. Alternatively, in one embodiment, the multi-type source assignment system may generate flexibility metric without first tentatively assigning L to fill the demands of order O. Instead, for example, the multi-type source assignment system makes no assignment to fill the demands of order O prior to performing the SWCoF calculation. This may be referred to as the “pre-assignment” method. Because no tentative assignment is performed for each location check, the pre-assignment method can run significantly faster than then post-assignment method. Therefore, in the discussion of the following formulas for the SWCOF flexibility metric, the quantities referred to have pre-assignment values.

Terms of EQs. 1 and 2 below have the following definitions:

$${SWCoF}_{L , O} = scarcity - weighted center of flexibility for location L supplying order O .$$

$$S ( T ) = scarcity of item type T = \frac{Total unassigned demand count for type T}{Total available supply count for type T}$$

$${n}_{L , d} ( T ) = Supply of item type T at location L on day d$$

$${N}_{L} ( L ) = {\sum }_{all days} {n}_{L , d} ( T ) = Total available supply of item T at location L$$

$$M ( O , T ) = the number of demands for item type T in order O$$

$${d}_{i} ( O , T ) = the day of the ith demand for item type T in order O ,$$

$$i ∈ \{ 1 , … , M ( O , T ) \}$$

In one embodiment, the SWCoF is given by the formula shown in EQ. 1:

$${SWCoF}_{L , O} = {\sum }_{T ∈ all itemtypes} S ( T ) {N}_{L} ( T ) \frac{1}{M ( O , T )} {\sum }_{i = 1}^{M ( O , T )} \frac{{\sum }_{D = 1}^{{d}_{i} ( O , T )} {n}_{L , D} ( T ) ( {d}_{i} ( O , T ) - D )}{{\sum }_{D = 1}^{{d}_{i} ( O , T )} {n}_{L , D} ( T )} \qquad EQ . 1$$

The scarcity-weighted center of flexibility for location L, supplying order O generated according to EQ. 1 is a flexibility metric for location L to supply order O.

In EQ. 1 above, the term 1/M(O,T) serves to find the average of the inner sum (that is, the sum over i∈{1, . . . , M(O,T)} that produces the unweighted center of flexibility) to account for situations where there is more than one demand for a given item type T in a given order O. As a practical matter, individual orders almost never include demands for multiple quantities of the same item type, and the value of the term 1/M(O,T) evaluates to 1, and may thus be dropped from the flexibility metric equation EQ. 1, as shown in EQ. 2:

$${SWCoF}_{L , O} = {\sum }_{T ∈ all itemtypes} S ( T ) {N}_{L} ( T ) {\sum }_{i = 1}^{M ( O , T )} \frac{{\sum }_{D = 1}^{{d}_{i} ( O , T )} {n}_{L , D} ( T ) ( {d}_{i} ( O , T ) - D )}{{\sum }_{D = 1}^{{d}_{i} ( O , T )} {n}_{L , D} ( T )} \qquad EQ . 2$$

Note that the inner sum which describes the core, unweighted center of flexibility only runs over the days prior to the fill-by date of the given demand. This mode of operation was compared experimentally with other possibilities and found to be, marginally, the best of the possibilities. For example, this mode of operation was compared with using a single date for the entire order (such as the earliest of all demand dates), and compared with using the farthest future date in the calendar while including all the supply of the location in the sum.

### —Example Graphical User Interface—

In one embodiment, multi-type source assignment system 100 may present one or more user interfaces. User interfaces may include graphical user interfaces (GUIs) and command line interfaces (CLIs) through which end users and administrators may access and use the multi-type source assignment system 100 and/or other components of an operations management system. For example, through GUIs and CLIs, end users and/or administrators may provide inputs that cause multi-type source assignment method 200 to be performed.

FIG. 4 illustrates an example graphical user interface 400 associated with selection of supply locations from among multiple candidate locations in order to maximize fulfillment of orders that include multiple item types when there is a shortage of one or more of the item types. Graphical user interface 400 includes an example multi-type source assignment tool 405. Multi-type source assignment tool 405 displays supply-to-order assignments in a graphical display. Multi-type source assignment tool 405 accepts user inputs to adjust parameters of one or more supplies and/or one or more orders.

In one embodiment, multi-type source assignment tool 405 displays a configuration of assignments of orders to supplies over a range of days for which assignment analysis is performed. During the days of the range for assignment analysis, supplies may become available and/or orders may become due. In the example of FIG. 4, the orders and supplies are configured in the manner that the orders are proposed to be filled according to a set of assignments. In one embodiment, the set of assignments is generated as described above with reference to method 200 and FIG. 2. In one embodiment, the order-to-supply assignments shown in multi-type source assignment tool 405 are similar to those shown and described with reference to FIG. 3 above.

Multi-type source assignment tool 405 includes an orders region 410 and a supplies region 415. Orders region 410 displays various orders. The orders are represented in orders region 410 as icons. Orders region 410 includes representative depictions of a plurality of orders, including order O1 421, order O2 422, order O3 423, order O4 424, order O5 425, and order O6 426. The orders include demands for multiple item types. For example, order O3 423 includes a first demand 427 for a quantity of the circular item type, a second demand 428 for the triangular item type, and a third demand 429 for the square item type. The demands are represented in the orders as pairs of item type and quantity. While the item types of demands and supplies are represented graphically in FIG as circles, triangles, and squares, in one embodiment, they may be represented alphanumerically, for example by item SKU or other identifier for item type.

Supplies region 415 represents various supplies of specific item types as icons, including supply S1 431, supply S2 432, supply S3 433, supply S4 434, and supply S5 435. Supplies may be described with quantities of a particular item type available for assignment, and quantities that are already assigned to orders according to the set of assignments. For example, these may be expressed as ratios 436 of the assigned quantity to the total quantity for each supply of a given item type. Supplies region 415 also represents various candidate locations for filling the orders. Candidate locations are represented in the supplies region 415 as rows in a matrix 440. For example, in example multi-type source assignment tool 405, there are three warehouses that are candidate locations for providing supplies: location 1 441, location 2 442, and location 3 443. And, the orders are represented as an additional row 445 of matrix 440. Matrix 440 is displayed across both order region 410 and supply region 415. A sequence of days (or other units of time) from an initial start day of a range for assignment analysis is represented as columns in matrix 440. For example, day 0 (Monday) 450, day 1 (Tuesday) 451, day 2 (Wednesday) 452, and day 3 (Thursday) 453 are shown in matrix 440.

Where the range for assignment analysis is wider than can be showed in the tool (in this example, a range of more than three days following the initial date) columns for additional days up to and including a final day of the range for assignment analysis may be brought into the view in the graphical user interface 400 by scrolling the matrix 440 from side to side. Where there are more orders due on a particular date than can be shown in a single cell for a given date in row 445, additional orders may be included in the cell, and brought into view by scrolling the orders. And, where there are more supplies than can be displayed in the cells for individual dates and locations, the cells may also be scrolled to reveal the additional supplies.

Supplies become available for distribution on at the location and on the day shown in matrix 440. For example, supply S1 431, supply S2 432, supply S3 433 become available at location 1 441 on day 0 450, while supply S4 434 and supply S5 435 become available at location 1 441 on day 1. Another group of supplies 460 becomes available at location 2 442 on day 2 452, a further group of supplies 461 becomes available at location 2 442 on day 3 453, yet another group of supplies 462 becomes available at location 3 443 on day 2 452, and still another group of supplies 463 becomes available at location 3 443 on day 3 453.

The multi-type source assignment system parses the supply data structures of the various supplies to determine the item type, quantity, availability date, and source location of supplies. The multi-type source assignment system then generates the representations of the supplies shown in multi-type source assignment tool 405 based on the item type and quantity parsed from the supply data structure, and places the representations of the supplies in positions of the matrix 440 that correspond to the source location and availability date parsed from the supply data structures.

Similarly, multi-type source assignment system parses the supply data structures of the various orders to determine the one or more item types and quantities in the orders, and the due date of the order. The multi-type source assignment system then generates the representations of the orders shown in multi-type source assignment tool 405 based on the item types and quantities parsed from the order data structure, and places the representations of the orders in positions of the row 445 that correspond to the due date parsed from the order data structures.

Further, the multi-type source assignment system parses the set of assignments to determine the configuration of assignments between the supplies and orders. In one embodiment, the set of assignments indicate that orders are assigned either no source of supplies, or are assigned supplies from one of the locations (in this example, one of location 1 441, location 2 442, or location 3 443). Multi-type source assignment system parses the set of assignments to determine whether or not an order has been assigned a source of supply. In one embodiment of multi-type source assignment tool 405, orders that have not been assigned a source of supply may be shown with greyed out, obscured, or otherwise visually differentiated from items that have been assigned a source of supply. For example, order O1 421 and order O6 426 are shown with dotted outlines, differentiating these orders from other orders that have been assigned a source of supply.

Multi-type source assignment system also parses the set of assignment to determine the location that is the source of supplies for an order that has been assigned a source of supply. In one embodiment, the determined location is then applied to the representation of the order as a label of the associated supply source. For example, order O2 422 and order O3 423 are both supplied from location 1, and are labeled accordingly with “L1” 465. And, order O4 424 and order O5 425 are supplied from locations and 3, respectively, and are labeled accordingly with “L2” 467 and “L3” 469.

In one embodiment, upon launch of multi-type source assignment tool 405, multi-type source assignment tool 405 prompts for and requests: (i) a range of days for which the assignment analysis is to be performed; and (ii) file location or other data location indicating the collections of orders to be assigned sources of supply for multiple item types and the collection of sources of supply for the multiple item types. In one embodiment, multi-type source assignment tool 405 automatically sets a pre-set default range and data location to perform the analyses. In one embodiment, in response to receiving a specification of the range of days and the collections of orders and supplies, the multi-type source assignment tool 405 launches an initial generation of a set of assignments to pre-populate the multi-type source assignment tool 405 with a visual representation of a valid assignment solution. Thus, in one embodiment, the initial set of assignments is generated in response to the launch of multi-type source assignment tool 405. Then, data structures for the orders, and the supplies, and the generated assignments between the orders and supplies are parsed to obtain the one or more item types and corresponding quantities for each order and due dates for each order; item type and corresponding quantity for each supply, location for each supply, and availability date for each supply; as well as a status for each order of whether or not it has been assigned supply, and if so, the location of the assigned source. From these parsed values, visual indications of the orders are generated and placed into the corresponding date position in multi-type source assignment tool 405 (e.g., in row 445 in orders region 410). And, visual indications of the supplies are generated and placed into the corresponding location and date position in multi-type source assignment tool 405 (for example in matrix 440 in supplies region 415). The populated multi-type source assignment tool 405 may then be transmitted for presentation on a display device.

As discussed above, the initial generation, population and transmission of the graphical user interface 400 may be performed in real time, where this was not previously possible. This allows an immediate real time configuration of the user interface at startup to present an initial valid solution based on the current parameters of the supplies and orders. The real time operation at the initial state prevents the user from sensing a delay that might indicate to a user that multi-type source assignment tool 405 has failed or is hanging.

In one embodiment, multi-type source assignment tool 405 represents the orders and supplies along a timeline. The timeline may be broken down into a sequence of days or other time increments, as represented by the columns of matrix 440. Note that while we refer to days herein, other time increments may be used, including minutes, hours, weeks, months, etc., based on the time scale at which supplies become available and orders are dispatched. Days are therefore used herein as an example, default increment.

As discussed above, multi-type source assignment tool 405 is interactive in real time. In one embodiment, multi-type source assignment tool 405 will accept a user input that changes one or more parameters of one or more orders or supplies, and automatically re-generate and display a set of assignments based on the changed parameter(s). In one embodiment, there are delays of seconds or less to re-generate or update the set of assignments and present the updated assignment solution in response to an adjustment of the orders or supplies.

In one embodiment, a GUI may include user-manipulable elements for inputting information or commands. Examples of user-manipulable elements of a GUI include user-selectable graphical buttons, radio buttons, menus, checkboxes, drop-down lists, scrollbars, sliders, spinners, text boxes, icons, labels, progress bars, status bars, toolbars, windows, hyperlinks, and dialog boxes. User-manipulable elements of a GUI include the graphical representations (icons) of supplies (such as supply 1 431) and orders (such as order 2 422). In one example, GUI elements may be selected or manipulated by a user to enter information to be parsed and used by multi-type source assignment system 100. In one example, GUI elements may be manipulated or interacted with by mouse clicks, mouse drag-and-drops, cursor hovers over the element, or other operations of a cursor controller or text input device.

In one embodiment, the regeneration process, for example as shown and described with reference to blocks 215-255 of method 200, may be initiated in response to one or more triggers. As discussed above, the multi-type source assignment system accepts user one or more user inputs to re-configure the set of assignments displayed in multi-type source assignment tool 405. The input(s) cause the re-generation process to be launched. Once the re-generation process is complete, multi-type source assignment tool 405 updates to display a re-generated set of assignments that reflect a new assignment solution. The new assignment solution has been updated to reflect the user-input changes.

In one embodiment, the completion of the user input may trigger the re-generation of the set of assignments. In one embodiment, the re-generation may commence automatically in response to the completion of a single input action. In this case, the set of assignments is re-generated based on a change to the set of assignments indicated by the single input. In one embodiment, a series of input actions may be performed, followed by a final input causing the prior changes to be committed and the re-generation launched. In this case, when the changes are committed, the new configuration of the parameters of the orders and/or supplies are stored. The set of assignments is then re-generated based on the multiple changes indicated by the series of input actions. In one embodiment, a commit button input 475 may be selected to cause a sequence of prior changes or adjustments to be saved, and the set of assignments re-generated based on the changes or adjustments. In one embodiment, multi-type source assignment tool 405 is user-configurable to select one of launching re-generation automatically upon completion of one action, or launch re-generation upon selection of a commit button input 475, following one or more modifications to order or supply parameters.

Changes to parameters may be made in a variety of ways. In one embodiment, order icons (such as order 2 422) and supply icons (such as supply 1 431) may be dragged and dropped within various display regions of multi-type source assignment tool 405. In one embodiment, icons representing supplies or orders may be dragged and dropped from one day to another day in matrix 440. In one embodiment, the representations of orders and supplies may be dragged and dropped to change associated dates. For example, in response to the drag of an icon representing an order from a position associated with a first day (e.g., day 0 450) and drop into a position associated with a second day (e.g., day 2 452), the due date in the order data structure of the dragged-and-dropped order is updated from the due date being on the first day to the due date being on the second day. Or, similarly, in response to the drag of a supply from one position associated with the first day and drop into a second position associated with the second day, the availability date in the supply data structure of the dragged-and-dropped supply is updated from the availability date being on the first day to the availability date being on the second day. In one embodiment, icons representing supplies may be dragged and dropped from a first location to second location in matrix 440. This drag and drop causes the location in the supply data structure to be updated from the first location to the second location. In one embodiment, the drag and drop of a supply may update both the availability date and the location.

In one embodiment, other changes to the parameters of orders or supplies include changes to quantity or to item type. In one embodiment, the quantity and item type parameters of orders and supplies may be accessed through the icons corresponding to the orders and supplies. In one embodiment, the multi-type source assignment tool 405 may accept a click input on an icon for a supply or order to access a menu associated with the supply or order. In one embodiment, the click input includes a mouse click (right-clicking or left-clicking) when the cursor is hovering over the icon associated with the supply or order. Then, multi-type source assignment tool 405 may accept a further click input or keyboard input to adjust the quantity or item type parameters. (In one embodiment, a click or keyboard input may also be made within the menu to adjust the due date parameter of orders or availability date parameter or location parameter of supplies). In one embodiment, the menu associated with the supply or order may be shown as a pop-up region that hovers over some portion of multi-type source assignment tool 405.

In one embodiment, these changes to parameters of the orders and supplies are made in the data structures prior to re-generating the set of assignments. In one embodiment, in response to a drag-and-drop of a supply or order icon in multi-type source assignment tool 405, multi-type source assignment system 100 will automatically update the parameters in the affected data structures and initiate the re-generation process. Therefore, when the set of assignments is re-generated, the re-generated set of assignments will be based on the adjusted parameters of the orders.

Note that the rapid re-generation offered by the multi-type source assignment techniques herein allows for multiple iterations of interactions with multi-type source assignment tool 405 with real-time presentation of results.

In one embodiment, hovering a cursor over (or performing some other interaction with) an order or a supply causes multi-type source assignment tool 405 to present a popup region including information describing the order or supply. In one embodiment, in response to hovering a cursor over an order, a popup region providing details of the assignment for the order is automatically presented. In one embodiment, in response to hovering the cursor over the order, multi-type source assignment tool 405 also highlights the source supplies for the demand. In one embodiment, the popup region may include one or more of a listing of demand quantities by item type, order due date, a breakdown of supply that was assigned to fill the order (e.g., indicating a listing of one or more supplies used to fill the order, the location of the one or more supplies, a unit type and quantity of units assigned from the one or more supplies and/or the assignment status (assigned/unassigned) of other units from those supplies), or other information about the order.

In one embodiment, in response to hovering a cursor over a supply, a popup region including information providing details of the assignments from the supply is automatically presented. In one embodiment, in response to hovering the cursor over the supply, multi-type source assignment tool 405 also highlights the orders that are filled wholly or in part from the supply. In one embodiment, the popup region may include one or more of item type of the supply, quantity of the supply, availability date of the supply, a breakdown of the orders filled by the supply (e.g., indicating a listing of one or more orders filled partially or wholly by the supply and a count of units of supply assigned to the one or more orders), or other information about the supply.

At some point, the configuration of assignments between supplies and orders may become satisfactory to a user performing the interactive configuration analyses using the multi-type source assignment tool 405. At this stage, the user may wish to approve a current configuration and cause the configuration to be implemented. In one embodiment, multi-type source assignment tool 405 includes a “finalize configuration” button 480 to approve a final set of assignments between the multi-type orders and the supplies. In one embodiment, selecting the “finalize configuration” button 380 acts to select the currently displayed configuration of assignments for implementation by a warehouse automation system or other order fulfillment system. “Finalize configuration” button 380 is thus a user-selectable option to fill the demands in accordance with the set of assignments between multi-type orders and supplies.

In one embodiment, in response to selection of button 380, multi-type source assignment system 100 will automatically generate an allocation instruction to fill demands in accordance with the set of assignments displayed. In one embodiment, the allocation instruction is an electronic message that specifies, for one or more orders, the supply location and specific supplies that the orders are to be filled from. The allocation instruction may include part or all of the set of assignments. For example, the allocation instruction may be made up of a plurality of parts, each of which parts is specific to one of the supply locations. The allocation instruction for a given supply location includes a portion of the set of assignments that includes the assignments for all orders that are filled from the given supply location.

The multi-type source assignment system 100 will then automatically transmit the allocation instruction to an order fulfillment system (such as a warehouse automation system). For example, the allocation instruction for one of the source locations may be transmitted to a warehouse automation system that operates (or is otherwise associated with) the source location. In one embodiment, the order fulfillment system (such as a warehouse automation system) parses the allocation instruction and executes it to cause the demands to be automatically filled in accordance with the set of assignments. In one embodiment, the such as a warehouse automation system generates control instructions to operate equipment of the warehouse automation system to carry out the allocation instructions. In one embodiment, the allocation instruction initiates and or controls activities performed in order to fulfill the demands. For example, the allocation instruction may cause: (i) printing, display, or transmission (for example by email, fax, text, Electronic Data Interchange or other protocol) of pick and/or pack instructions to the location in order to effect the fulfillment of the orders using the assigned supplies; or (ii) one or more robots or other automated equipment at the location to retrieve the identified supply quantities of units, pack the retrieved units, and ship the packed units to fulfill the demand using the assigned supplies.

### —Experimental Validation—

FIG. 5 illustrates a plot of results of simulation runs 500 of multi-type source assignment techniques using differing location selection criteria. Data points for the multi-type source assignment technique with three variations of the location selection criteria are plotted against a number of days axis 505 and a fraction of orders filled axis 510. Each of the variations select the supply location to fill an order based on a different technique. A first set of data points 515 is shown for a multi-type source assignment technique that selects the location having the least value for the SWCoF flexibility metric to fill the order. A second set of data points 520 is shown for a multi-type source assignment technique that selects the location at random to fill the order. A third set of data points 525 is shown for a multi-type source assignment technique that selects the location having the greatest value for the SWCoF flexibility metric to fill the order.

Each data point represents 25 simulated runs over randomly generated scenarios with an average of results of the 25 simulated runs. The data points are for scenarios that cover gradually increasing numbers of days. For example, in the context of FIG. 3, the value of day d 320 is incremented for each data point, increasing the number of days along the timeline 310 (or calendar) between day 0 315 and day d 320. For a given number of days, the three data points plotted for the number of days applied show the respective results of the three different location selection methods applied to the same 25 randomly generated scenarios.

The technique of choosing the location having the least value for the SWCoF (shown by first set of data points 515) is compared with two other techniques: random selection (shown by second set of data points 520); and a method that selects the location having the largest SWCoF (shown by third set of data points 515), although it uses a slightly different metric for center of flexibility. The latter is shown in plot of simulation runs 500 for comparison because it approximates a technique in which the system starts with the earliest supply, and moves forward along the timeline assigning as the system proceeds. This “most SWCoF” performs least well, generally resulting in a fraction of orders filled that falls below the other techniques. This is visible from the position of third set of data points 525 below the other sets of data points. The random selection of candidate locations performs slightly better: it tends to spread selection around evenly, rather than choose based on supply metrics. This “random selection” thus slightly outperforms the “most SWCoF” technique in terms of fraction of orders filled, but still underperforms the “least SWCoF”. This is visible from the position of the second set of data points 520 above the third set of data points 525, and below the first set of data points 515.

In one embodiment, the multi-type source assignment techniques shown and described herein implement the “least SWCoF” technique for selecting supply locations, for example as described with reference to blocks 235-240 of method 200 above. In plot 500, it is seen from the first set of data points 515 that, in one embodiment, the “least SWCoF” technique produces 5 to 10% better results than the other two methods in the smaller numbers of days, and still remains at least marginally better for longer calendars.

FIG. 6 illustrates a plot of execution times 600 of simulation runs of multi-type source assignment techniques using differing location selection criteria. In plot of execution times 600, execution times for the averaged runs discussed above with reference to FIG. 5 are plotted against a number of days axis 605 and a runtime axis 610. Each of the 25 problems used in getting the datapoints shown in FIGS. 5 and 6 represents a random value between 1 and 30 orders per day and a random number of ordered items totaling in the hundreds. The runtime includes an order sort time that precedes the assignment process, but the order sort time is constant across all runs. Therefore, the effect of the 3 selection methods on runtime may be readily compared. Regardless of selection method, the results are all returned in less than a second, even for timelines in excess of 40 days. Each of these methods may therefore be used to drive a user interface in real time for interactive rearrangement of order-to-supply assignments.

Many dozens of runs have been completed for various values of the simulation set up, with results similar to those shown in FIGS. 5 and 6. Generally, the multi-type source assignment technique based on choosing the least value for the scarcity weighted center of flexibility performs at least as well as the others, or somewhat better, depending on the problem. For example, on a problem with a large number item types (such as 10 discrete types of items) that are all scarce, and a large number days (for example, 45 days) and a large number of candidate supply locations (for example, 20 locations), there is no significant difference among the selection methods with regard to fill rate. But for more modest problems, choosing the least value for the scarcity weighted center of flexibility gives reliably better fill rate than the other selection methods. The largest runtime encountered in simulation is 2 seconds.

Thus, the selection method based on selecting the candidate location with the least value for the SWCoF flexibility metric generally yields better fill rate than the two other methods, and runs quickly enough for interactive use. Various ways to compute the center of mass flexibility term have been examined, and selecting the candidate location with the least value for the SWCoF flexibility metric reliably fills the most orders.

### —Selected Advantages—

Time complexity of the methods for multi-type source assignment as shown and described herein is drastically improved over Simplex (or other solver) implementation. Conventional solvers such as Simplex that search for a true optimum must perform complex operations that are typically in proportion to combinatorially large functions of the number of variables. Further, Simplex and other solvers cannot be stopped early and arrive at a valid solution. Finding a solution using a Simplex implementation arrives at a solution in exponential time, and may further have large memory or storage requirements. This results in infeasibly high runtimes for even moderate order-to-supply assignment problems. Note, the multi-type source assignment techniques produce a good result, which may be the true optimum result, or which may closely approach the optimum result. This is satisfactory for the purpose of interactive exploration of adjustments to the order/supply configuration. Simplex and similar solvers will only produce a true optimum, but the process of obtaining the true optimum is so onerous and slow to arrive that real-time operation (for example in response to adjustments of the order/supply configuration to further improve the solutions) is infeasible.

Thus, the high runtimes of Simplex and other classic solvers preclude their use for generating assignments between multi-type orders and supplies for interactive user interfaces. The use of the multi-type source assignment techniques as shown and described herein enables the system to arrive at a solution to generating assignments between multi-type orders and supplies in linear time, with far smaller memory or storage requirements compared to the Simplex algorithm or other classic solvers. Thus, the systems and methods for multi-source assignment arrive at solutions to the problem of assigning supplies from one of a set of sources to demands much more quickly and efficiently than was previously possible.

This comparison is based on execution multi-type source assignment techniques as shown and described herein and for the Simplex implementation using equivalent (or the same) benchmark hardware configurations. Note that in tests, the systems and methods described herein performed thousands of times faster than the Simplex method. Therefore, these improvements in speed and performance are not caused by brute force application of computing power, but by the inventive processes shown and described herein for multi-source assignment.

The drastic reduction in the compute (processor) time and storage requirements enables the real-time or quasi-real-time generation of assignment solutions needed for interactive, exploratory revision of multi-type source assignment configurations in a user interface. Before the introduction of the multi-type source assignment techniques as described herein, such interactive exploration was not possible.

### —Cloud or Enterprise Embodiments—

In one embodiment, the present system (such as multi-type source assignment system 100) is a computing/data processing system including a computing application or collection of distributed computing applications for access and use by other client computing devices that communicate with the present system over a network. In one embodiment, multi-type source assignment system 100 is a component of a time series data service that is configured to gather, serve, and execute operations on time series data. The applications and computing system may be configured to operate with or be implemented as a cloud-based network computing system, an infrastructure-as-a-service (IAAS), platform-as-a-service (PAAS), or software-as-a-service (SAAS) architecture, or other type of networked computing solution. In one embodiment the present system provides at least one or more of the functions disclosed herein and a graphical user interface to access and operate the functions. In one embodiment, multi-type source assignment system 100 is a centralized server-side application that provides at least the functions disclosed herein and that is accessed by many users by way of computing devices/terminals communicating with the computers of multi-type source assignment system 100 (functioning as one or more servers) over a computer network. In one embodiment multi-type source assignment system 100 may be implemented by a server or other computing device configured with hardware and software to implement the functions and features described herein.

In one embodiment, the components of multi-type source assignment system 100 may be implemented as sets of one or more software modules executed by one or more computing devices specially configured for such execution. In one embodiment, the components of multi-type source assignment system 100 are implemented on one or more hardware computing devices or hosts interconnected by a data network. For example, the components of multi-type source assignment system 100 may be executed by network-connected computing devices of one or more computing hardware shapes, such as central processing unit (CPU) or general-purpose shapes, dense input/output (I/O) shapes, graphics processing unit (GPU) shapes, and high-performance computing (HPC) shapes.

In one embodiment, the components of multi-type source assignment system 100 intercommunicate by electronic messages or signals. These electronic messages or signals may be configured as calls to functions or procedures that access the features or data of the component, such as for example application programming interface (API) calls. In one embodiment, these electronic messages or signals are sent between hosts in a format compatible with transmission control protocol/internet protocol (TCP/IP) or other computer networking protocol. Components of multi-type source assignment system 100 may (i) generate or compose an electronic message or signal to issue a command or request to another component, (ii) transmit the message or signal to other components of multi-type source assignment system 100, (iii) parse the content of an electronic message or signal received to identify commands or requests that the component can perform, and (iv) in response to identifying the command or request, automatically perform or execute the command or request. The electronic messages or signals may include queries against databases. The queries may be composed and executed in query languages compatible with the database and executed in a runtime environment compatible with the query language.

In one embodiment, remote computing systems may access information or applications provided by multi-type source assignment system 100, for example through a web interface server. In one embodiment, the remote computing system may send requests to and receive responses from multi-type source assignment system 100. In one example, access to the information or applications may be effected through use of a web browser on a personal computer or mobile device. In one example, communications exchanged with multi-type source assignment system 100 may take the form of remote representational state transfer (REST) requests using JavaScript object notation (JSON) as the data interchange format for example, or simple object access protocol (SOAP) requests to and from XML servers. The REST or SOAP requests may include API calls to components of multi-type source assignment system 100.

### —Software Module Embodiments—

In general, software instructions are designed to be executed by one or more suitably programmed processors accessing memory. Software instructions may include, for example, computer-executable code and source code that may be compiled into computer-executable code. These software instructions may also include instructions written in an interpreted programming language, such as a scripting language.

In a complex system, such instructions may be arranged into program modules with each such module performing a specific task, process, function, or operation. The entire set of modules may be controlled or coordinated in their operation by an operating system (OS) or other form of organizational platform.

In one embodiment, one or more of the components described herein are configured as modules stored in a non-transitory computer readable medium. The modules are configured with stored software instructions that when executed by at least a processor accessing memory or storage cause the computing device to perform the corresponding function(s) as described herein.

### —Computing Device Embodiment—

FIG. 7 illustrates an example computing system 700 that is configured and/or programmed as a special purpose computing device(s) with one or more of the example systems and methods described herein, and/or equivalents. The example computing device may be a computer 705 that includes at least one hardware processor 710, a memory 715, and input/output ports 720 operably connected by a bus 725. In one example, the computer 705 may include multi-type source assignment logic 730 configured to facilitate selection of supply locations from among multiple candidate locations in order to maximize fulfillment of orders that include multiple item types when there is a shortage of one or more of the item types similar to the logic, system 100, method 200, and other embodiments shown and described with reference to FIGS. 1-6.

In different examples, the logic 730 may be implemented in hardware, one or more non-transitory computer-readable media 737 with stored instructions, firmware, and/or combinations thereof. While the logic 730 is illustrated as a hardware component attached to the bus 725, it is to be appreciated that in other embodiments, the logic 730 could be implemented in the processor 710, stored in memory 715, or stored in disk 735.

In one embodiment, logic 730 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application-specific integrated circuit (ASIC) programmed to facilitate selection of supply locations from among multiple candidate locations in order to maximize fulfillment of orders that include multiple item types when there is a shortage of one or more of the item types. The means may also be implemented as stored computer executable instructions that are presented to computer 705 as data 740 that are temporarily stored in memory 715 and then executed by processor 710.

Logic 730 may also provide means (e.g., hardware, non-transitory computer-readable medium that stores executable instructions, firmware) for performing one or more of the disclosed functions and/or combinations of the functions.

Generally describing an example configuration of the computer 705, the processor 710 may be a variety of various processors including dual microprocessor and other multi-processor architectures. A memory 715 may include volatile memory and/or non-volatile memory. Non-volatile memory may include, for example, read-only memory (ROM), programmable ROM (PROM), and so on. Volatile memory may include, for example, random access memory (RAM), static RAM (SRAM), dynamic RAM (DRAM), and so on.

A storage disk 735 may be operably connected to the computer 705 via, for example, an input/output (I/O) interface (e.g., card, device) 745 and an input/output port 720 that are controlled by at least an input/output (I/O) controller 747. The disk 735 may be, for example, a magnetic disk drive, a solid-state drive, a floppy disk drive, a tape drive, a Zip drive, a flash memory card, a memory stick, and so on. Furthermore, the disk 735 may be a compact disc ROM (CD-ROM) drive, a CD recordable (CD-R) drive, a CD rewritable (CD-RW) drive, a digital video disc ROM (DVD ROM) drive, and so on. The storage/disks thus may include one or more non-transitory computer-readable media. The memory 715 can store a process 750 and/or a data 740, for example. The disk 735 and/or the memory 715 can store an operating system that controls and allocates resources of the computer 705.

The computer 705 may interact with, control, and/or be controlled by input/output (I/O) devices via the input/output (I/O) controller 747, the I/O interfaces 745, and the input/output ports 720. Input/output devices may include, for example, one or more network devices 755, displays 770, printers 772 (such as inkjet, laser, or 3D printers), audio output devices 774 (such as speakers or headphones), text input devices 780 (such as keyboards), cursor control devices 782 for pointing and selection inputs (such as mice, trackballs, touch screens, joysticks, pointing sticks, electronic styluses, electronic pen tablets), audio input devices 784 (such as microphones or external audio players), video input devices 786 (such as video and still cameras, or external video players), image scanners 788, video cards (not shown), disks 735, and so on. Input/output devices may also include a warehouse automation system 790. Display 770 may be used to present a graphical user interface 792 for interaction with a user and presenting results of changes to order-to-supply assignments, such as graphical user interface 400 as shown and described with reference to FIG. 4. The input/output ports 720 may include, for example, serial ports, parallel ports, and USB ports.

The computer 705 can operate in a network environment and thus may be connected to the network devices 755 via the I/O interfaces 745, and/or the I/O ports 720. Through the network devices 755, the computer 705 may interact with a network 760. Through the network 760, the computer 705 may be logically connected to remote computers 765. Networks with which the computer 705 may interact include, but are not limited to, a local area network (LAN), a wide area network (WAN), and other networks.

The computer 705 may be connected to a warehouse automation system 790 through I/O ports 720 and/or networks 760 in order to control fulfillment of orders from one or more supply locations. The warehouse automation system 790 may include various automated equipment such as automated conveyors, carousels, shuttles, automated guided vehicles, robotic arms, automated storage and retrieval systems, item sorting and routing systems, pick/put-to-light systems, barcode and RFID (radiofrequency identification) inventory tracking systems and scanners, automated packing machines, palletizing systems, control and safety sensors, and the like. The automated equipment may be included in the input/output devices that are controllable by computer 705. The warehouse automation system and/or the automated equipment of an automated warehouse may be configured by control instructions to fulfill one or more orders in accordance with allocation instructions generated by multi-type source assignment logic 730. The warehouse automation system may be configured to operate in conjunction with an autonomous delivery system. The autonomous delivery system is configured to operate or direct the operations of autonomous delivery vehicles such as robotic delivery vehicles, self-driving vehicles, drones, and the like.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A computer-implemented method, comprising:
accessing a plurality of orders and a plurality of candidate locations for fulfilling the orders, wherein one or more of the orders include a plurality of item types;
generating a set of assignments between individual orders in the plurality of orders and candidate locations for fulfilling the individual orders by, for each of the individual orders:
(a) generating, for each candidate location, a flexibility metric that quantifies an extent to which the candidate location is able fulfill orders for the plurality of item types;
(b) comparing the flexibility metric for each candidate location to determine one candidate location that has a lowest flexibility metric; and
(c) assigning the individual order to be completely fulfilled from the one candidate location that has the lowest flexibility metric to form an assignment between the individual order and the one candidate location;
generating a user interface that displays the set of assignments between the individual orders and the candidate locations; and
in response to a user input to finalize the set of assignments, generating allocation instructions to allocate the plurality of item types from the candidate locations to the individual orders in accordance with the finalized set of assignments.

2. The computer-implemented method of claim 1, wherein generating the flexibility metric for a candidate location further comprises determining scarcity of supply for one or more of the plurality of item types, wherein the flexibility metric is based at least in part on the scarcity of supply.

3. The computer-implemented method of claim 1, wherein generating the flexibility metric for a candidate location further comprises:
determining scarcity of supply for each item type of the plurality of item types;
determining daily supplies of each item type that are in inventory in the candidate location;
determining total supplies of each item type that are available over multiple days in the candidate location;
determining a number of demands for each item type in the individual order; and
determining a day that the demands occurs for each item type;
wherein the flexibility metric for a candidate location is generated based on the scarcity of supply, the daily supplies, the total supplies, the number of demands, and the day that the demand occurs for each item type.

4. The computer-implemented method of claim 1, wherein prior to generating a flexibility metric for each candidate location, the method further comprises filtering out one or more candidate locations from the plurality of candidate locations based on a geographic proximity of the candidate location to a delivery destination of the individual order.

5. The computer-implemented method of claim 1, wherein prior to prior to generating a flexibility metric for each candidate location, the method further comprises filtering out one or more candidate locations from the plurality of candidate locations based on a shelf-life of one or more items types in the individual order.

6. The computer-implemented method of claim 1, further comprising:
accepting a second user input through the user interface, wherein the second user input adjusts parameters of one or more of the individual orders or one or more of the candidate locations;
in response to the user input, re-generating the set of assignments between the individual orders and the candidate locations in real time based on the adjusted parameters; and
updating the user interface in real time to display the re-generated set of assignments.

7. The computer-implemented method of claim 1, wherein:
the individual orders are represented by order data structures that include a demand date for fulfillment of the order, and one or more demand quantities for one or more of the plurality of item types;
the candidate locations are represented by location data structures that include a geographic position for the candidate location and one or more supplies for one or more of the plurality of item types; and
the supplies are represented by supply data structures that include one or more supply quantities for one or more of the plurality of item types and one or more availability dates when the supply becomes available at the candidate location for fulfilling orders.

8. The computer-implemented method of claim 1,
wherein generating the allocation instructions further comprises generating a first allocation instruction for a particular candidate location that includes a subset of the orders that are assigned to the particular candidate location for fulfillment; and
wherein the method further comprises:
transmitting the allocation instruction to a warehouse automation system that is configured to fulfill orders from the particular candidate location;
in response to receiving the allocation instruction, parsing the allocation instruction to generate control instructions for fulfilling the subset of the orders; and
executing the control instructions by the warehouse automation system to automatically fulfill the subset of the orders.

9. One or more non-transitory computer-readable media that include stored thereon computer-executable instructions that when executed by a computer system cause the computer-system to:
access a plurality of orders and a plurality of candidate locations for fulfilling the orders, wherein one or more of the orders include a plurality of item types;
generate an assignment between an individual order in the plurality of orders and a candidate location for completely fulfilling the individual order, wherein the assignment is selected based on a flexibility metric that describes how readily the candidate location can fulfill orders for the plurality of item types;
in response to generating the assignment, update the flexibility metric for the candidate location to reflect the assignment of a supply from the candidate location to fulfill the individual order, wherein the steps of generating the assignment and updating the flexibility metric are iterated for each individual order in the plurality of orders to produce a set of assignments between the plurality of orders and the plurality of candidate locations;
present the set of assignments in a user interface configured to accept a user input to finalize the set of assignments; and
allocate the plurality of item types from the candidate locations to the individual orders in accordance with the finalized set of assignments.

10. The non-transitory computer-readable media of claim 9, wherein the instructions further cause the computer system to generate the flexibility metric for the candidate location based at least in part on a scarcity of supply for one or more of the plurality of item types.

11. The non-transitory computer-readable media of claim 9, wherein the instructions further cause the computer system to generate the flexibility metric for the candidate location based at least in part on quantities and availability dates for supplies of each item type in the candidate location.

12. The non-transitory computer-readable media of claim 9, wherein the instructions further cause the computer system to, prior to generating the assignment, filter out one or more candidate locations from the plurality of candidate locations based on (i) a geographic proximity of the candidate location to a delivery destination of the order or (ii) a shelf-life of one or more items types in the order.

13. The non-transitory computer-readable media of claim 9, wherein the instructions further cause the computer system to:
accept a user input that adjusts parameters of one or more of the individual orders or one or more of the candidate locations;
automatically update a user interface that displays the set of assignments between individual orders and candidate locations in real time in response to the user input.

14. The non-transitory computer-readable media of claim 9, wherein the instructions to allocate the plurality of item types from the candidate locations to the individual orders in accordance with the set of assignments further cause the computer system to control automated warehouse equipment of one or more of the candidate locations to automatically fulfill the orders according to the set of assignments.

15. A computer system comprising:
a processor;
a memory operably connected to the processor;
a display device configured with a user interface to show an interactive set of assignments;
one or more non-transitory computer-readable media operably connected to the processor, wherein the non-transitory computer-readable media includes stored thereon computer-executable instructions that when executed by the processor and memory of the computer system cause the computer-system to:
present the set of assignments between individual orders in a plurality of orders and candidate locations for fulfilling the individual orders in the user interface, wherein one or more of the orders include a plurality of item types;
accept a first user input that adjusts (i) one or more of the individual orders or (ii) one or more of the candidate locations;
in response to the user input, re-generate the set of assignments between the individual orders and the candidate locations as adjusted in real-time, wherein the set of assignments is re-generated by, for each of the individual orders:
(a) generating, for each candidate location, a flexibility metric that indicates an extent to which the candidate location can fulfill further orders for the plurality of item types; and
(b) selecting one location of the candidate locations that has a lowest value for the flexibility metric to fulfill the individual order to assign the individual order to the one location in the re-generated set of assignments;
automatically update the user interface to display the re-generated set of assignments; and
generate and transmit allocation instructions to allocate the plurality of item types from the candidate locations to the individual orders in accordance with the re-generated set of assignments.

16. The computer system of claim 15, wherein the instructions for generating the flexibility metric for a candidate location further cause the computer system to:
determine scarcity of supply for each individual item type of the plurality of item types;
determine a center of flexibility to provide the plurality of item types that are available in the candidate location over increments of time that precede an increment of time on which the individual order is to be fulfilled; and
determine the flexibility metric for the candidate location at least in part by weighting the contribution of the individual item type to the center of flexibility by the respective scarcity of supply for the individual item type.

17. The computer system of claim 15, wherein the instructions for generating the flexibility metric for a candidate location further cause the computer system to:
determining scarcity of supply for each item type of the plurality of item types;
determining daily supplies of each item type that are on hand in the candidate location;
determining total supplies of each item type that are available over multiple days in the candidate location;
determining a number of demands for each item type in the individual order; and
determining a day that the demands occurs for each item type;
wherein the flexibility metric for a candidate location is generated based on the scarcity of supply, the daily supplies, the total supplies, the number of demands, and the day that the demand occurs for each item type.

18. The computer system of claim 15, wherein the instructions further cause the computing system to generate control instructions for a warehouse automation system from the allocation instructions, wherein the control instructions are configured to cause the warehouse automation system to automatically fulfill one or more of the individual orders from an assigned location that is assigned to the one or more of the individual orders in the re-generated set of assignments.

19. The computer system of claim 15, further comprising:
a warehouse automation system configured to fulfill orders for the plurality of item types from one or more of the candidate locations; and
wherein the instructions further cause the warehouse automation system to:
in response to the allocation instructions, generate control instructions for fulfilling one or more of the individual orders by the warehouse automation system from an assigned location that is assigned to the individual order in the re-generated set of assignments; and
execute the control instructions to automatically fulfill the one or more of the individual orders from the assigned location.

20. The computer system of claim 15, wherein the instructions to generate the flexibility metric for a candidate location further cause the computer system to determine a total amount of supply that is available in the candidate location, wherein the flexibility metric is based at least in part on the total amount of supply.
